(19) United States
(12) Patent Application Publication
(10) Pub. No.: US 2025/0214240 A1
(43) Pub. Date: Jul. 3, 2025

(54) METHOD AND SYSTEM OF GRASP GENERATION FOR A ROBOT

(71) Applicant: Sanctuary Cognitive Systems Corporation, Vancouver (CA)

(72) Inventors: Evgeny Andriyash, Vancouver (CA); Eric Langlois, Vancouver (CA)

(21) Appl. No.: 18/973,589

(22) Filed: Dec. 9, 2024

Related U.S. Application Data
(60) Provisional application No. 63/616,119, filed on Dec. 29, 2023.

(51) Int. Cl. B25J 9/16; B25J 15/00

(52) U.S. Cl. CPC B25J 9/1669; B25J 9/1612; B25J 15/0004; B25J 15/0009

(57) ABSTRACT

A method of grasp generation for a robot includes searching within a configuration space of a robot hand model for robot hand configurations to engage an object model with a grasp type. The method includes generating a set of candidate grasps based on the robot hand configurations. Grasping of the object model with the robot hand model is simulated in a physics engine using simulated grasps generated based on a given candidate grasp. A simulated grasp is assigned a score based on a response of the object model to an applied wrench disturbance when the object is engaged with the simulated grasp. The method includes generating a set of feasible grasps for the given candidate grasp based on the respective simulated grasps having a score above a score threshold at a target wrench disturbance.

### CROSS-REFERENCE TO RELATED APPLICATIONS

This application claims the benefit of U.S. Provisional Application No. 63/616,119, filed Dec. 29, 2023, the content of which is incorporated herein by reference.

### FIELD

The field generally relates to machine-human systems and particularly to grasp planning.

### BACKGROUND

Robots are machines that can sense their environment and perform tasks semi-autonomously or autonomously or via teleoperation. A humanoid robot is a robot or machine having an appearance and/or character resembling that of a human. Humanoid robots can be designed to function as team members with humans in diverse applications, such as construction, manufacturing, monitoring, exploration, learning, and entertainment. Humanoid robots can be particularly advantageous in substituting for humans in environments that may be dangerous to humans or uninhabitable by humans or in work that is repetitive.

### SUMMARY

Disclosed herein are technologies for generating grasps that can be used during task planning for a robotic hand.

In a representative example, a method of grasp generation for a robot includes searching within a configuration space of a robot hand model for a plurality of robot hand configurations to engage an object model with a grasp type. The method includes generating a set of candidate grasps based on the plurality of robot hand configurations. The method includes simulating grasping of the object model with the robot hand model a plurality of times for a given candidate grasp from the set of candidate grasps. Each simulating grasping of the object model includes generating a simulated grasp based on the given candidate grasp, executing the simulated grasp in a physics engine to cause the robot hand model to engage the object model with the simulated grasp, applying a wrench disturbance to the object model while the robot hand model engages the object model with the simulated grasp in the physics engine, measuring a response of the object model to the applied wrench disturbance, and assigning a grasp stability score to the simulated grasp based on the measured response. The method includes generating a set of feasible grasps for the given candidate grasp based on the respective simulated grasps having individual grasp stability scores above a grasp stability score threshold at a target wrench disturbance.

In another representative example, a system includes a first processing block configured to receive a grasp template, a robot model, and an object model and output a set of candidate grasps for a robot hand model extracted from the robot model to engage the object model with a grasp type specified in the grasp template. The system includes a second processing block configured to simulate grasping of the object model with the robot hand model in a physics engine for a given candidate grasp from the set of candidate grasps and output a plurality of simulated grasps with assigned grasp stability scores for the given candidate grasp. The system includes a third processing block configured to generate a set of feasible grasps from the plurality of simulated grasps based on the grasp stability scores.

### BRIEF DESCRIPTION OF THE DRAWINGS

FIG. 1 is a schematic of an example robot.

FIG. 2 is a perspective view of an example robotic hand.

FIG. 3A is a diagram of a kinematic structure of the robotic hand shown in FIG. 2.

FIG. 3B is a schematic illustrating graspable parts on a graspable object.

FIG. 3C is a schematic illustrating graspable parts on a graspable object.

FIGS. 4A-4P illustrate grasp types using the robotic hand shown in FIG. 2.

FIG. 5A is a diagram of a kinematic structure of a virtual finger assignment for the grasp type shown in FIG. 4B.

FIG. 5B illustrates the kinematic structure of FIG. 5A relative to the kinematic structure of FIG. 3A.

FIG. 6 is a block diagram of an example grasp generation system.

FIG. 7 is a flow diagram of an example grasp generation method.

FIG. 8 is a flow diagram of an example method of generating a closing motion of a grasp trajectory.

FIG. 9A illustrates a method of determining a closed position for generating a closing motion of a grasp trajectory for a grasp type having two virtual fingers mapped to two physical fingers.

FIG. 9B illustrates a method of determining a closed position for generating a closing motion of a grasp trajectory for a grasp type having two virtual fingers mapped to three physical fingers.

FIG. 9C illustrates a method of determining a closed position for generating a closing motion of a grasp trajectory for a grasp type having three virtual fingers mapped to three physical fingers.

FIG. 10 illustrates a method of determining a closed position for generating a closing motion of a grasp trajectory for a grasp type having two virtual fingers with one of the virtual fingers including a palm.

### DETAILED DESCRIPTION

For the purpose of this description, certain specific details are set forth herein in order to provide a thorough understanding of disclosed technology. In some cases, as will be recognized by one skilled in the art, the disclosed technology may be practiced without one or more of these specific details, or may be practiced with other methods, structures, and materials not specifically disclosed herein. In some instances, well-known structures and/or processes associated with robots have been omitted to avoid obscuring novel and non-obvious aspects of the disclosed technology.

All the examples of the disclosed technology described herein and shown in the drawings may be combined without any restrictions to form any number of combinations, unless the context clearly dictates otherwise, such as if the proposed combination involves elements that are incompatible or mutually exclusive. The sequential order of the acts in any process described herein may be rearranged, unless the context clearly dictates otherwise, such as if one act or operation requests the result of another act or operation as input.

In the interest of conciseness, and for the sake of continuity in the description, same or similar reference characters may be used for same or similar elements in different figures, and description of an element in one figure will be deemed to carry over when the element appears in other figures with the same or similar reference character, unless stated otherwise. In some cases, the term “corresponding to” may be used to describe correspondence between elements of different figures. In an example usage, when an element in a first figure is described as corresponding to another element in a second figure, the element in the first figure is deemed to have the characteristics of the other element in the second figure, and vice versa, unless stated otherwise.

The word “comprise” and derivatives thereof, such as “comprises” and “comprising”, are to be construed in an open, inclusive sense, that is, as “including, but not limited to”. The singular forms “a”, “an”, “at least one”, and “the” include plural referents, unless the context dictates otherwise. The term “and/or”, when used between the last two elements of a list of elements, means any one or more of the listed elements. The term “or” is generally employed in its broadest sense, that is, as meaning “and/or”, unless the context clearly dictates otherwise. When used to describe a range of dimensions, the phrase “between X and Y” represents a range that includes X and Y. As used herein, an “apparatus” may refer to any individual device, collection of devices, part of a device, or collections of parts of devices.

The term “coupled” without a qualifier generally means physically coupled or lined and does not exclude the presence of intermediate elements between the coupled elements absent specific contrary language. The term “plurality” or “plural” when used together with an element means two or more of the element. Directions and other relative references (e.g., inner and outer, upper and lower, above and below, and left and right) may be used to facilitate discussion of the drawings and principles but are not intended to be limiting.

The headings and Abstract are provided for convenience only and are not intended, and should not be construed, to interpret the scope or meaning of the disclosed technology.

### Example I—Overview

Described herein is a technology for generating feasible grasps for stable grasping of an object using a robotic hand. The feasible grasps can be stored in a grasp database and associated with the robotic hand and object. During task planning for the robotic hand, a feasible grasp can be selected from the grasp database based on the type and part of the object to be grasped in a task. The technology can generate candidate grasps that include feasible and unfeasible grasps. In some examples, the candidate grasps (or simulated grasps based on the candidate grasps) can be incorporated into a training dataset for a machine learning system that can be trained to automatically generate feasible grasps for the robotic hand and an arbitrary object.

### Example II—Example Robot

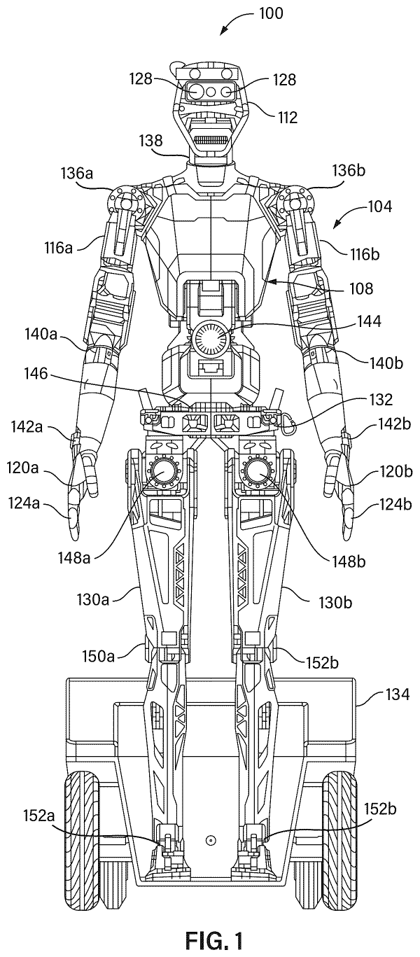

FIG. 1 illustrates an exemplary robot 100 having robotic hands that can be actuated to grasp objects. Although the robot 100 is illustrated as a humanoid robot, the examples described herein are not limited to humanoid robots (e.g., non-humanoid robots can have robotic hands to grasp objects and can benefit from the grasp generation technology described herein). Moreover, how closely the robot 100 approximates the human anatomy can be selected for a given application (e.g., the robot 100 can have greater or fewer human anatomical features than shown in FIG. 1).

In the illustrated example, the robot 100 includes a robot body 104 having a robotic torso 108, a robotic head 112, robotic arms 116a, 116b, and robotic hands (or end effectors) 120a, 120b. The robotic arms 116a, 116b are coupled to opposite sides of the robotic torso 108. Each robotic hand 120a, 120b is coupled to a free end of a respective arm 116a, 116b. The robotic hands 120a, 120b can include one or more articulable digits (or fingers) 124a, 124b. The robotic head 112 can include one or more image sensors 128 that can capture visual data representing an environment of the robot. The robot 100 can include other sensors that can collect data representing the environment of the robot (e.g., audio sensors, tactile sensors, accelerometers, inertial sensors, gyroscopes, temperature sensors, humidity sensors, or radiation sensors).

The robot 100 can have robotic legs 130a, 130b, which can be coupled to the torso 108 by a hip 132. In the illustrated example, the robotic legs 130a, 130b are mounted on a mobile base 134. In some examples, the robot 100 can walk with the robotic legs 130a, 130b and use the mobile base 134 as a secondary mobile transport. In other examples, the robot 100 may not have any legs and can still be considered to have a humanoid form. In these other examples, the robotic torso 108 can include a base that can be mounted on a pedestal, which can be attached to a mobile base to facilitate transportation of the robot.

The robot 100 includes several joints having degrees of freedom (DOFs) that can be controlled by actuators. For example, the robot 100 can include shoulder joints 136a, 136b between the robotic arms 116a, 116b and robotic torso 108 and a neck joint 138 between the robotic head 112 and robotic torso 108. The robotic arms 116a, 116b can include elbow joints 140a, 140b. Wrist joints 142a, 142b can be formed between the robotic arms 116a, 116b and the robotic hands 120a, 120b. The robotic torso 108 can include various joints, such as a joint 144 that allows flexion-extension of the torso and a joint 146 that allows rotation of the torso 108 relative to the hip 132. Hip joints 148a, 148b can be formed between the robotic hip 132 and the robotic legs 130a, 130b. The robotic legs 130a, 130b can include knee joints 150a, 150b and ankle joints 152a, 152b.

### Example III—Robot Model

A robot (e.g., the robot 100 in FIG. 1) can be modeled as a system of links and joints. Actuators can be associated with the joints and used to control the DOFs of the joints.

In some examples, the robot model can include a kinematic model. In some examples, the kinematic model can be specified in a United Robot Description Format (URDF). URDF is an XML format for representing a robot model. The URDF model can contain a set of link elements and a set of joint elements connecting the links together. The URDF model can contain transmission elements, which are actuators and relationships between the actuators and the joints. In some examples, the URDF model can include one or more meshes for visualizing the robot and collision checking of the robot. The URDF model and meshes can be generated from a computer-aided design (CAD) model of the robot.

In some examples, the robot model includes metadata. In some examples, the metadata can be specified in a Semantic Robot Description Format (SRDF). SRDF is an XML format for representing semantic information about robots. For example, the SRDF model can group the joints in the URDF model into semantic units (e.g., joints that form a left hand of the robot can be grouped into one semantic unit). The SRDF model or metadata can include other information, such as default robot configurations, additional collision checking information, contact points on the robot (e.g., links on the robot that can contact other objects), and additional transforms to specify the pose of the robot.

### Example IV—Example Robot Hand

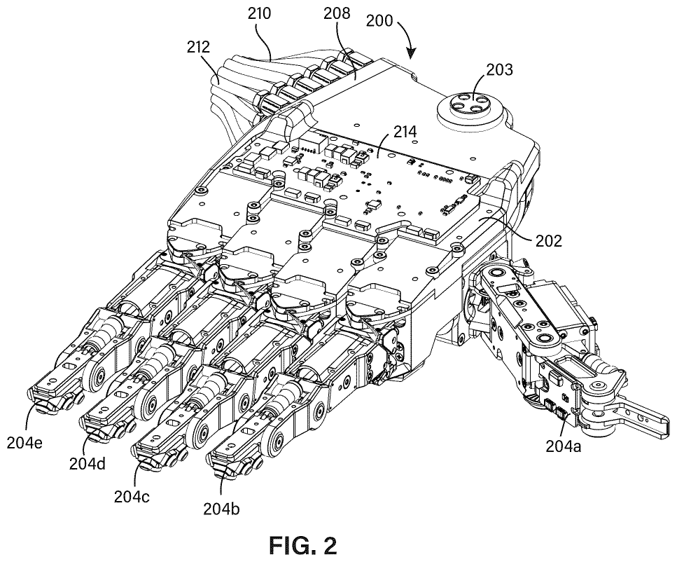

FIG. 2 illustrates an exemplary robotic hand 200 having a shape and functionality similar to that of a humanoid hand. For example, the robotic hand 200 can grasp, grip, handle, touch, or release objects similar to how a human hand would. The robotic hand 200 can include a palm 202, which can have an interface 203 for connection to a robotic arm (e.g., any of the robotic arms 116a, 116b in FIG. 1 and Example II). The robotic hand 200 includes articulable fingers (e.g., thumb 204a, index finger 204b, middle finger 204c, ring finger 204d, and pinkie 204e) coupled to the palm 202. Although the robotic hand 200 is illustrated with five fingers, the examples described herein are not limited to robotic hands with five fingers (e.g., the robotic hand can have fewer than or greater than five fingers).

In the illustrated example, the robotic fingers 204a-e are coupled to the palm 202 by actuatable joints. The robotic fingers 204a-e have links and joints that can be articulated to emulate movements and poses of humanoid fingers. For example, the robotic fingers 204a-e can be bent or extended to transform the robotic hand 200 between open hand configurations, grasping configurations, and closed hand configurations. Further details regarding the thumb 204a can be found, for example, in U.S. Provisional Application No. 63/464,758. Further details regarding the fingers 204b-e can be found, for example, in U.S. Provisional Application No. 63/342,414.

In some examples, the actuatable joints of the robotic fingers 204a-e can be hydraulically-actuatable joints. The robotic hand 200 can include a plate 208 mounted to a side of the palm 202. The plate 208 can carry quick couplings for a tube bundle 210 that can be connected to a hydraulic system. The tube bundle 210 can include hydraulic tubes 212 extending through paths in the palm 202 to various ports of various hydraulic actuators in the robotic hand 200.

Although the robotic hand 200 is illustrated as a hydraulically-actuated hand, the grasp generation technology disclosed herein is not limited to a hydraulically-actuated hand and could be applied to any hand in general regardless of how the joints in the hand are actuated. For example, the joints of the robotic fingers 204a-e could be actuated by electrical actuators, cable-drive mechanisms, or other suitable actuating mechanisms.

In some examples, a printed circuit board 214 can be mounted on the palm 202 (e.g., on the backside of the palm 202) and include various circuitry for operation of the robotic hand 200. Additional circuit boards can be mounted on the robotic fingers 204a-e.

In some examples, tactile sensors can be positioned on the contact surfaces (e.g., inner surfaces) and tips of the robotic fingers 204 and on the contact surface (e.g., inner surface) of the palm 202 to provide haptic feedback as the robotic hand 200 interacts with surfaces and objects. In some examples, the tactile sensors can be fluid-based sensors, such as described in U.S. patent application Ser. No. 18/219,392.

### Example V—Robot Hand Model

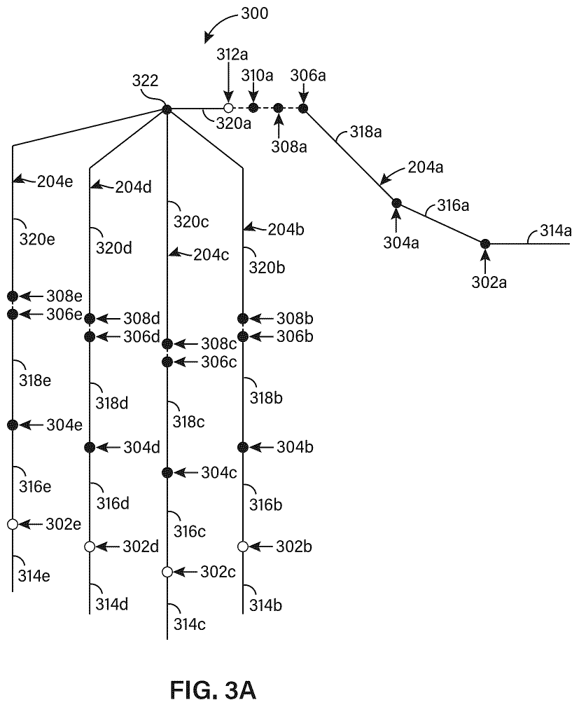

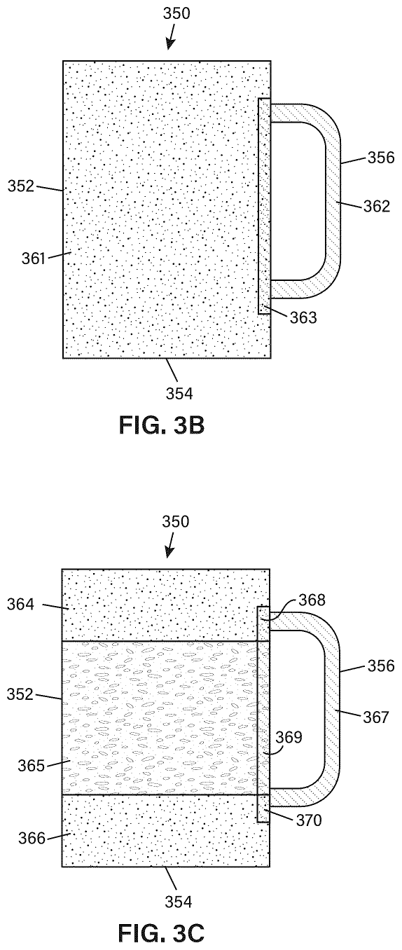

FIG. 3A illustrates an example kinematic structure 300 (e.g., a system of links and joints) for the example robotic hand 200 (see Example IV). Each joint can have one or more actuators to control one or more DOFs associated with the joint. A robot hand model can be constructed based on the kinematic structure 300. The robot hand model can include a kinematic model and metadata for the kinematic model.

The thumb 204a (see FIG. 2) includes a thumb interphalangeal (IP) joint having a thumb IP flexion DOF 302a, a thumb metacarpal (MCP) joint having a thumb MCP flexion DOF 304a, a thumb carpometacarpal (CMC) joint having a thumb CMC flexion DOF 306a, a thumb CMC abduction DOF 308a, and two thumb CMC opposition DOFs 310a, 312a. In some examples, the thumb CMC opposition DOFs 310a, 312a are functionally coupled together. The thumb IP flexion DOF 304a is formed between a thumb distal phalanx 314a and a thumb proximal phalanx 316a. The thumb MCP flexion DOF 304a is formed between the thumb proximal phalanx 316a and a thumb MCP 318a. The thumb CMC DOFs 306a, 308a, 310a, 312a are formed between the thumb MCP 318a and a thumb base 320a, which is connected to a wrist joint 322 (which can be formed at the interface 203 in FIG. 2). In some examples, the wrist joint 322 can have six DOFs (not shown separately).

The index finger 204b (see FIG. 2) includes an index finger distal interphalangeal (DIP) joint having an index finger DIP flexion DOF 302b, an index finger proximal interphalangeal (PIP) joint having an index finger PIP flexion DOF 304b, and an index finger MCP joint having an index finger MCP flexion DOF 306b and an index finger MCP abduction DOF 308b. The index finger DIP flexion DOF 302b is formed between an index finger distal phalanx 314b and an index finger middle phalanx 316b. The index finger PIP flexion DOF 304b is formed between the index finger middle phalanx 316b and an index finger proximal phalanx 318b. The index finger MCP DOFs 306b, 308b are formed between the index finger proximal phalanx 318b and an index finger MCP 320b. The index finger MCP 320b is connected to the wrist joint 322.

The middle finger 204c (see FIG. 2) includes a middle finger DIP joint having a middle finger DIP flexion DOF 302c, a middle finger PIP joint having a middle finger PIP flexion DOF 304c, and a middle finger MCP joint having a middle finger MCP flexion DOF 306c and a middle finger MCP abduction DOF 308c. The middle finger DIP flexion DOF 302c is formed between a middle finger distal phalanx 316c and a middle finger middle phalanx 318c. The middle finger PIP flexion DOF 304c is formed between the middle finger middle phalanx 318c and a middle finger proximal phalanx 320c. The middle finger MCP DOFs 306c, 308c are formed between the middle finger proximal phalanx 318c and a middle finger MCP 320c. The middle finger MCP 320c is connected to the wrist joint 322.

The ring finger 204d includes a ring finger DIP joint having a ring finger DIP flexion DOF 302d, a ring finger PIP joint having a ring finger PIP flexion DOF 304d, and a ring finger MCP joint having a ring finger MCP flexion DOF 306d and a ring finger MCP abduction DOF 308d. The ring finger DIP flexion DOF 302d is formed between a ring finger distal phalanx 314d and a ring finger middle phalanx 316d. The ring finger PIP flexion DOF 304d is formed between the ring finger middle phalanx 316d and a ring finger proximal phalanx 318d. The ring finger MCP DOFs 306d, 308d are formed between the ring finger proximal phalanx 318d and a ring finger MCP 320d. The middle finger MCP 320d is connected to the wrist joint 322.

The pinkie 204e includes a pinkie DIP joint having a pinkie DIP flexion DOF 302e, a pinkie PIP joint having a pinkie PIP flexion DOF 304e, and a pinkie MCP joint having a pinkie MCP flexion DOF 306e and a pinkie MCP abduction DOF 308e. The pinkie DIP flexion DOF 302e is formed between a pinkie distal phalanx 314e and a pinkie middle phalanx 316e. The pinkie PIP flexion DOF 304e is formed between the pinkie middle phalanx 316e and a pinkie proximal phalanx 318e. The pinkie MCP DOFs 306e, 308e are formed between the pinkie proximal phalanx 318e and a pinkie MCP 320e. The pinkie MCP 320e is connected to the wrist joint 322.

In the illustrated example, the finger DOF space of the robot hand model has 22 DOFs, with the thumb 204a having 6 DOFs and each of the index, middle, ring, and pinkie fingers 204b-e having 4 DOFs. In some examples, only some of the DOFs in the finger DOF space are actively controlled. For example, only 17 DOFs may be actively controlled (e.g., the DIP DOFs 302b-e may not be actively controlled, e.g., the DIP DOF on a finger may be set to the same value as the PIP DOF on the same finger, and the CMC opposition DOFs 310a, 312a may be functionally coupled together so that only one of these DOFs needs to be actively controlled). Each DOF can have an associated actuator that can be operated to articulate the joint.

### Example VI—Object Model

A graspable object is an object having one or more graspable parts. A graspable part of an object is a part of an object that can be engaged by a robotic hand in a grasp action. The number of graspable parts that a graspable object can have can correspond to the number of different ways in which the object can be grasped by the robotic hand. A graspable part can have an object shape. In some examples, the object shape of the graspable part can be mapped to a 3D shape in a library of 3D shapes (e.g., to facilitate selection of a grasp type for the graspable part).

For illustrative purposes, FIG. 3B shows a mug 350 as an example of a graspable object. The mug 350 has a main body 352, a base 354 formed at one end of the main body 352, and a handle 356 attached to the main body 352. In one example, a graspable part definition for the mug 350 can include a first graspable part 361 including the main body 352 and a second graspable part 362 including the handle 356. The first graspable part 361 can have a collision area 363 that includes the portion of the main body 352 where the handle 356 is attached (a collision area can be an area of the graspable part that the robotic hand is not allowed to engage in a grasp action). In this first example, the first graspable part 361 has a cylindrical shape, and the second graspable part 362 has a hook (or curved handle) shape.

FIG. 3C shows another possible arrangement of graspable parts on the mug 350. In this example, an open end portion of the main body 352 is assigned to a first graspable part 364, a middle portion of the main body 352 is assigned to a second graspable part 365, and a closed end portion of the main body 352 is assigned to a third graspable part 366. The handle 356 is assigned to a fourth graspable part 367. The graspable parts 364, 365, 366 can have collision areas 368, 369, 370 that include the portion of the main body 352 where the handle 356 is attached. In this example, the first graspable part 364 and the third graspable part 366 have a disk shape, the second graspable part 365 has a cylindrical shape, and the fourth graspable part 367 has a hook shape.

In some examples, when a graspable object is added to an asset library, a 3D representation (e.g., mesh, point cloud, or voxel grid) of the object can be generated. In some examples, a platonic representation of the object can be generated from the 3D representation. A platonic representation is an approximation of the object by one or more geometric shapes. A method and system of generating a platonic representation of an object is described in U.S. Provisional Application No. 63/524,507 (“Systems, Methods, and Control Modules for Grasping by Robots”). For example, the following is an example of a platonic representation of a hammer object from U.S. Provisional Application No. 63/524,507:

def object(“hammer”):
parent_object_origin = [0, 0, 0]
platonic_01 = cylinder( )
platonic_01.scale = [0.6, 0.5, 0.3]
platonic_01.6dof_rel = [−0.5, 0, 0, 0, 0, 0]
platonic_01.constraints = rigid_body_to_origin
platonic_02 = cylinder( )
platonic_02.scale = [0.5, 0.4, 0.3]
platonic_02.6dof_rel = [0.1, 0, 0, 0, 0, 0]
platonic_02.constraints = rigid_body_to_origin
platonic_03 = cylinder( )
platonic_03.scale = [0.15, 0.5, 0.4]
platonic_03.6dof_rel = [0.3, 0, 0, 0, 0, 90]
platonic_03.constraints = rigid_body_to_origin

The platonic representation defines three geometric shapes based on a cylinder model. The geometric shapes have the identifiers platonic_01, platonic_02, and platonic_03. In some examples, each geometric shape identified in a platonic representation of an object can be used to generate a graspable part of the object.

An object model for a graspable object can include a 3D representation (e.g., mesh, point cloud, or voxel grid) of the object. The object model can include graspable parts of the object. Each graspable part can be a subset of the 3D representation of the object. In some examples, the graspable parts of the object can be derived from a platonic representation associated with the 3D representation of the object. The object model can include graspable part identifiers that can be used to select a particular graspable part for grasp planning. The object model can include physical attributes of the object (e.g., dimensions and weight of the object and the hardness of the object). The graspable part identifiers, physical attributes of the object, and other data related to the object can be included in the metadata for the object model.

### Example VII—Grasping

A grasp can be defined as a stable hold of an object using one hand. A grasp configuration can include a pre-grasp posture, a post-grasp posture, and a grasp trajectory to transform the robotic hand between the pre-grasp posture and the post-grasp posture.

A pre-grasp posture is any static posture a robotic hand adopts in preparation for grasping a given object. A post-grasp posture is any static posture the robotic hand adopts to securely hold the given object. In the post-grasp posture, the target contact points of the robotic hand engage the target graspable part of the object. The post-grasp posture is stable if the robotic hand can apply sufficient force to the given object through the contact points to securely hold the object in the hand.

A grasp trajectory can have a closing motion and an opening motion. The closing motion of the grasp trajectory can transform the robotic hand from a pre-grasp posture to a post-grasp posture. Further transformation of the robotic hand with the closing motion after the robotic hand has reached the post-grasp posture can serve to increase the amount of force applied to the object through the contact points of the robotic hand. The opening motion of the grasp trajectory can transform the robotic hand from a post-grasp posture to a pre-grasp posture.

### Example VII—Grasp Types

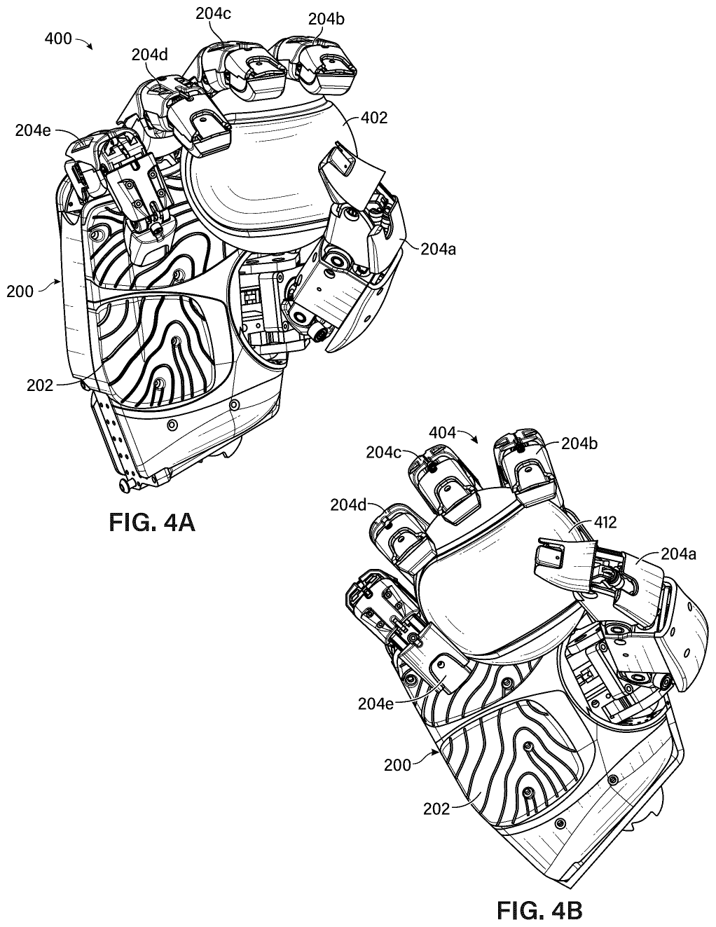

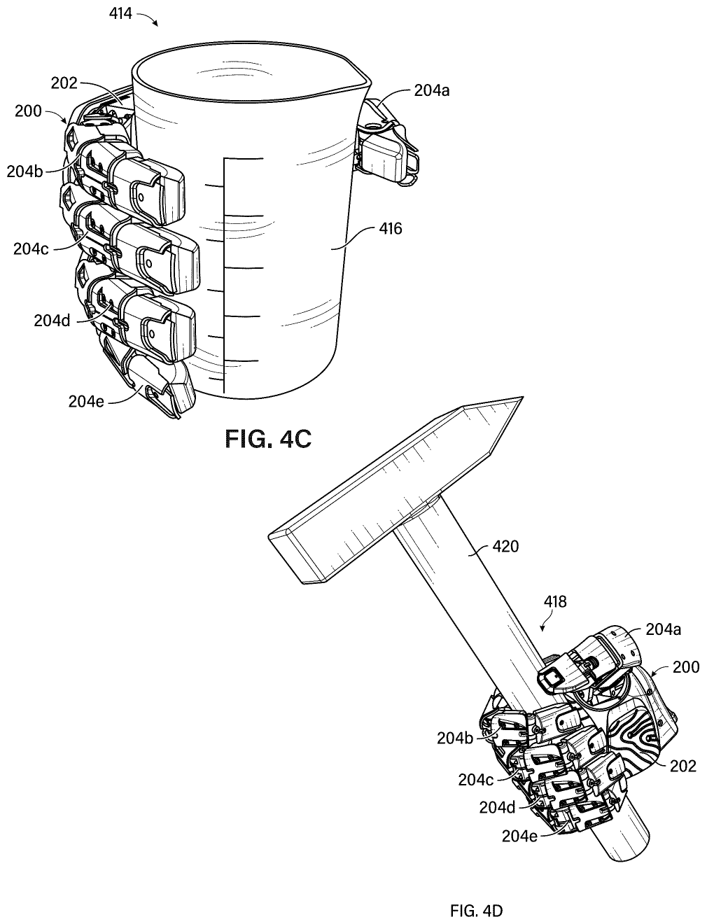

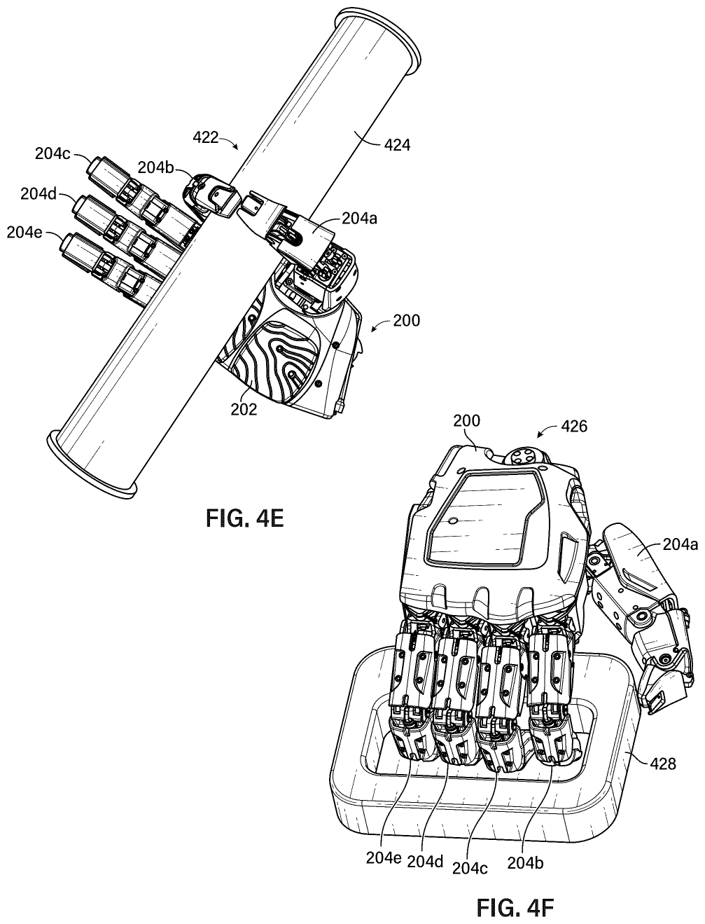

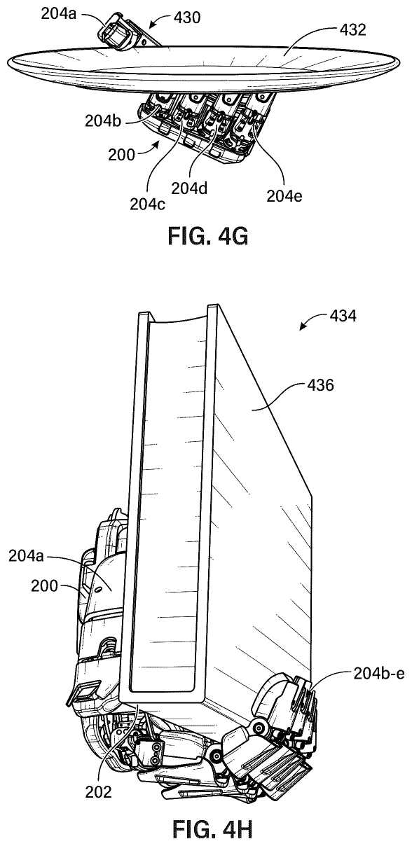

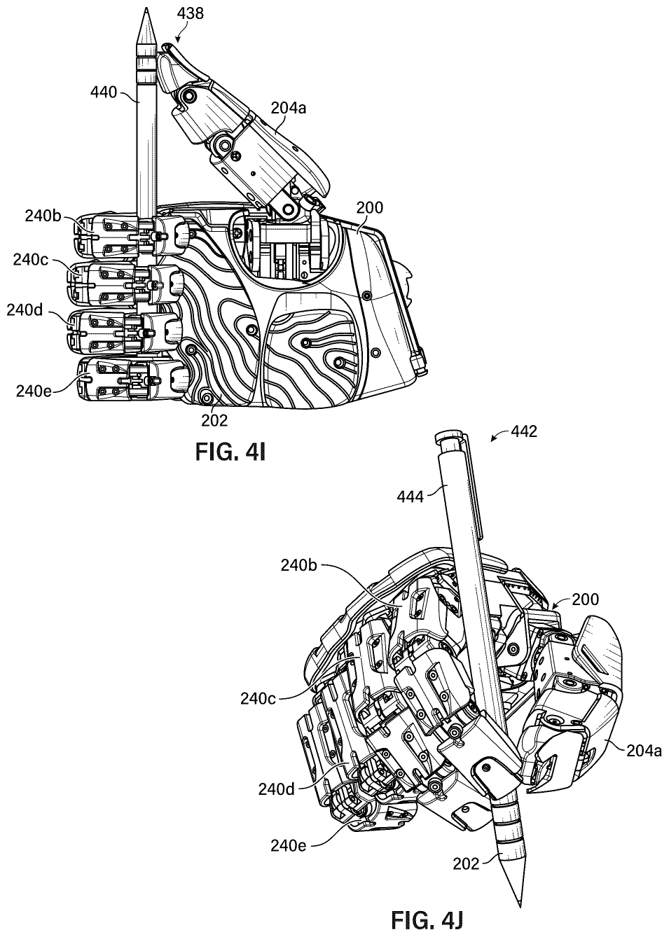

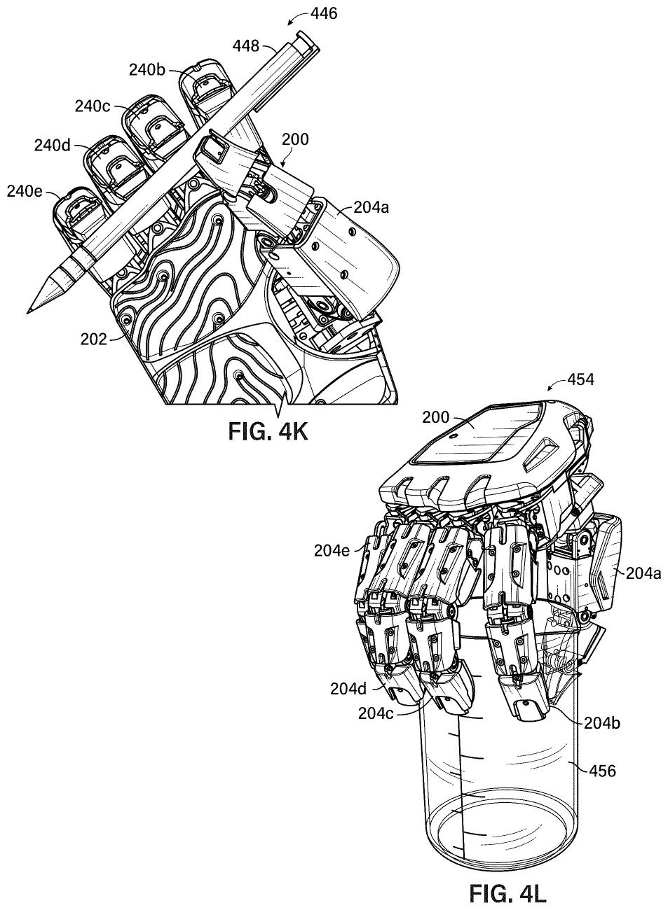

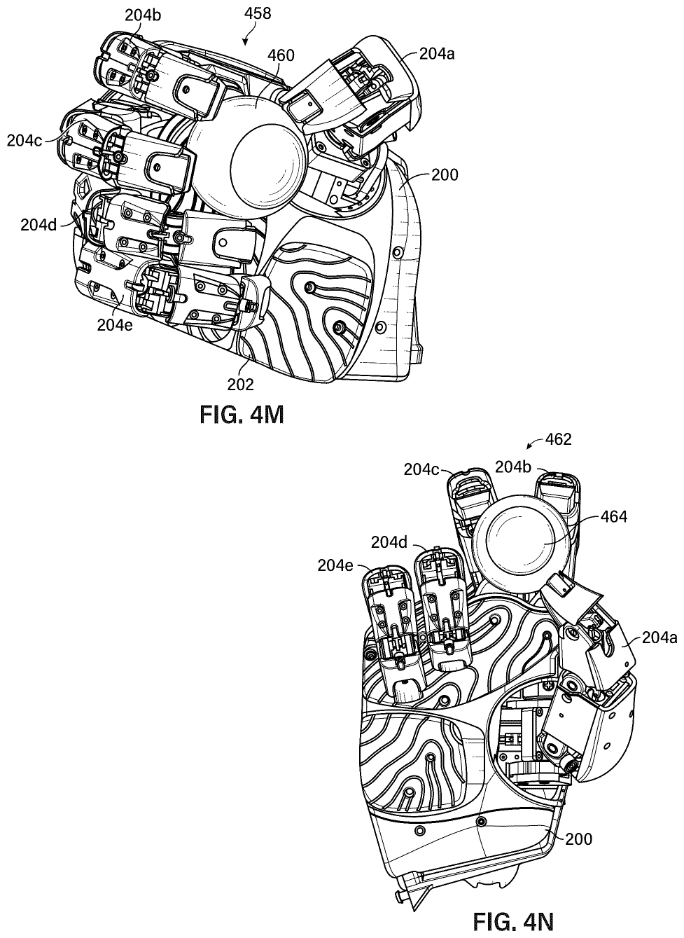

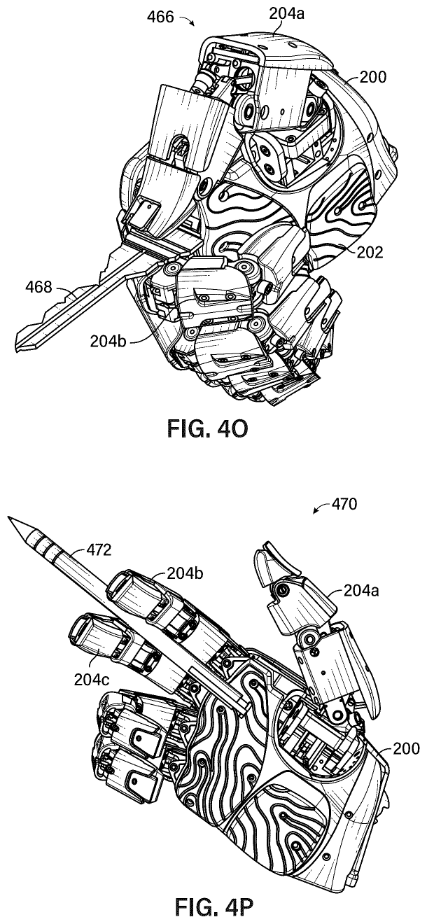

FIGS. 4A-4P illustrate example grasp types that can be formed using the robotic hand 200 (see Examples IV and V). Each grasp type may be identified as power grasp, precision grasp, or intermediate grasp. A power grasp involves rigid contact between the hand and the grasped object and typically requires movement of the arm to perform a task with the grasped object. A precision grasp allows finger dexterity while the object is grasped. An intermediate grasp includes elements of power grasp and precision grasp (see T. Feix, J. Romero, H. Schmiedmayer, A. M. Dollar, and D. Kragic, The GRASP Taxonomy of Human Grasp Types, IEEE Transactions on Human-Machine Systems, Vol. 46. No. 1, February 2016). Grasp types can have different form factors depending on the shape and dimensions of the grasped object.

FIG. 4A illustrates a small spherical power grasp 400 that can be used to grasp a small spherical object. In this example, the robotic hand 200 grasps a small spherical object 402 (e.g., a small ball) using the pads of the thumb, index, middle, and ring fingers 204a-d. The proximal and middle phalanxes of the fingers 204b-d and the proximal and distal phalanxes of the thumb 204a contact the spherical object 402. The pinkie 204e and the palm 202 do not contact the spherical object 402. The thumb 204a is in an abducted position.

FIG. 4B illustrates a large spherical power grasp 404 that can be used to grasp a large spherical object. In this example, the robotic hand 200 grasps a large spherical object 412 (e.g., a large ball) using the pads of the thumb, index, middle, ring, and pinkie fingers 204a-e and the palm 202. The proximal, middle, and distal phalanxes of the fingers 204b-e, the proximal and distal phalanxes of the thumb 204a, and the palm 202 contact the spherical object 412. The thumb 204a is in an abducted position.

FIG. 4C illustrates a medium cylindrical wrap power grasp 414 that can be used to grasp a medium-diameter cylindrical object. In this example, the robotic hand 200 grasps a medium-diameter cylindrical object 416 (e.g., a beaker) using the thumb, index, middle, ring, and pinkie fingers 204a-e and the palm 202. The proximal, middle, and distal phalanxes of the fingers 204b-e, the proximal and distal phalanxes of the thumb 204a, and the palm 202 contact and wrap around the diameter of the cylindrical object 416. The thumb 204a is in an abducted position.

FIG. 4D illustrates a small-diameter cylindrical wrap power grasp 418 that can be used to grasp a small-diameter cylindrical object. In this example, the robotic hand 200 grasps a small-diameter cylindrical object 420 (e.g., a handle of a hammer) using the pads of the thumb, index, middle, ring, and pinkie fingers 204a-e and the palm 202. The proximal, middle, and distal phalanxes of the fingers 204b-e, the proximal and distal phalanxes of the thumb 204a, and the palm 202 contact and wrap around diameter of the cylindrical object 420. The thumb 204a is in an abducted position.

FIG. 4E illustrates a ring power grasp 422 that can be used to grasp a small-diameter lightweight cylindrical object. In this example, the robotic hand grasps a small-diameter lightweight cylindrical object 424 (e.g., a small-diameter aluminum tube) using the thumb 204a and the index finger 204b. The thumb 204a and index finger 204b form a ring that encircles the diameter of the cylindrical object 424. The fingers 204c-e and the palm 202 do not engage the cylindrical object 424. The thumb 204a is in an abducted position.

FIG. 4F illustrates a hook power grasp 426 that can be used to grasp a hook (or curved handle) object. In this example, the robotic hand 200 grasps a hook object 428 using the pads of the index, middle, ring, and pinkie fingers 204b-e and the palm 202. The proximal, middle, and distal phalanxes of the fingers 204b-e and the palm 202 contact the hook object 428. The thumb 204a rests on a side of the hook object 428 in an adducted position. The power grasp 426 can be referred to as a hook power grasp.

FIG. 4G illustrates an extension power grasp 430 that can be used to grasp and extend a flat object. In this example, the robotic hand 200 grasps an edge portion of a flat object 432 (e.g., a plate) by engaging one side of the flat object 432 with the thumb 204a and the opposite side of the flat object 432 with the index, middle, ring, and pinkie fingers 204b-e. The distal phalanxes of the fingers 204a-e contact the flat object 432. The palm 202 does not engage the flat object 432. The thumb 204a is in an abducted position.

FIG. 4H illustrates a palmar gutter power grasp 434 that can be used to grasp a thick oblong object. In this example, the robotic hand 200 grasps an edge portion of a thick oblong object 436 (e.g., a spine portion of a book) in a gutter formed between the palm 202 and the index, middle, ring, and pinkie fingers 204b-e. The distal, middle, and proximal phalanxes of the fingers 204b-e and the palm 202 contact the oblong object 436. The thumb 204a rests on a side of the oblong object 436 in an adducted position.

FIG. 4I illustrates a lateral prehension power grasp 438 that can be used to grasp a narrow prismatic object. In this example, the robotic hand 200 grasps a narrow prismatic object 440 (e.g., a stylus) in a crook formed by the index, middle, ring, and pinkie fingers 204b-e. The thumb 204a stabilizes the grasp at a position offset from the fingers 204b-e. The thumb 204a is in an adducted position.

FIG. 4J illustrates a writing tripod precision grasp 442 that can be used to a grasp narrow prismatic object. In this example, the robotic hand 200 grasps a narrow prismatic object 444 between the distal phalanxes of the thumb, index, and middle fingers 204a-e. The palm 202 and the fingers 204d-e do not engage the prismatic object 444. The thumb 204a is in an abducted position. The precision grasp type 442 forms a tripod support.

FIG. 4K illustrates four-finger prismatic precision grasp 446 that can be used to grasp a narrow prismatic object. In this example, the robotic hand 200 grasps a grasp narrow prismatic object 448 (e.g., a stylus) between the distal phalanxes of the thumb, index, middle, ring, and pinkie fingers 204a-e. The palm 202 does not engage the narrow prismatic object 448. The thumb 204a is in an abducted position.

FIG. 4L illustrates a disk precision grasp 454 that can be used to grasp a circular or disk object. In this example, the robotic hand 200 grasps a circular object 456 (e.g., an end portion of a beaker) between the distal phalanxes of the thumb, index, middle, ring, and pinkie fingers 204a-e. The fingers 204a-e are spaced circumferentially about the circular object 456. The palm 202 does not engage the circular object 456. The thumb 204a is in an abducted position.

FIG. 4M illustrates a tetrapod precision grasp 458 that can be used to grasp a spherical object. In this example, the robotic hand 200 grasps a spherical object 460 (e.g., a ball) between the distal phalanxes of the thumb, index, middle, and ring fingers 204a-d. The thumb 204a is in an abducted position. The palm 202 and the pinkie 204e do not engage the spherical object 460. The precision grasp type 458 forms a tetrapod support and can be referred to as a tetrapod precision grasp.

FIG. 4N illustrates a tripod precision grasp 462 that can be used to grasp a spherical object. In this example, the robotic hand 200 grasps a spherical object 464 (e.g., a ball) between the distal phalanxes of the thumb, index, and middle fingers 204a-c. The thumb is in an abducted position. The palm 202 and the ring and pinkie fingers 204d-e do not engage the spherical object 464. The precision grasp type 462 forms a tripod support.

FIG. 4O illustrates a lateral pinch intermediate grasp 466 that can be used to grasp a flat object. In this example, the robotic hand 200 grasps a flat object 468 (e.g., a flat head of a key) using the distal phalanx of the thumb 204a and a lateral side of the proximal phalanx of the index finger 204b. The thumb 204 is in an adducted position. The palm 202 and the fingers 204c-e do not engage the flat object 468.

FIG. 4P illustrates a bipod intermediate grasp 470 that can be used to grasp a narrow prismatic object. In this example, the robotic hand 200 grasps a narrow prismatic object 472 (e.g., a stylus) between opposing lateral sides of the distal phalanxes of the index finger 204b and the middle finger 204c. The thumb 204a, the ring finger 204d, the pinkie 204e, and the palm 202 do not engage the narrow prismatic object 472.

### Example VIII—Virtual Fingers

In grasp planning, physical fingers that act in unison to apply force in a similar direction on a graspable part of an object can be grouped together into a functional unit called “virtual finger” (VF). Examples of virtual finger assignments are described herein for the example grasp types in Example VII. In the virtual finger assignments, THUMB means thumb 204a, INDEX means index finger 204b, MIDDLE means middle finger 204c, RING means ring finger 204d, PINKIE means pinkie 204e, and PALM means the palm 202 (see FIGS. 4A-4R). Physical fingers that are grouped together to form a virtual finger are enclosed within the same set of square brackets. Only the fingers that are involved in grasping are assigned virtual fingers in the illustrated virtual finger assignments.

An example virtual finger assignment for the small spherical power grasp 400 (see FIG. 4A) can include: VF1=[THUMB] and VF2-4=[INDEX, MIDDLE, RING].

An example virtual finger assignment for the large spherical power grasp 404 (see FIG. 4B) can include: VF1=[THUMB], VF2-4=[INDEX, MIDDLE, RING, PINKIE], VF6=[PALM].

An example virtual finger assignment for the medium cylindrical wrap power grasp 414 (see FIG. 4C) can include: VF1=[THUMB], VF2-5=[INDEX, MIDDLE, RING, PINKIE], and VF6=[PALM].

An example virtual finger assignment for the small-diameter cylindrical power grasp 418 (see FIG. 4D) can include: VF1=[THUMB], VF2-5=[INDEX, MIDDLE, RING, PINKIE], and VF6=[PALM].

An example virtual finger assignment for the ring power grasp 422 (see FIG. 4E) can include: VF1=[THUMB] and VF2=[INDEX].

An example virtual finger assignment for the hook power grasp 426 (see FIG. 4F) can include: VF1=[THUMB], VF2-5=[INDEX, MIDDLE, RING, PINKIE], and VF6=[PALM].

An example virtual finger assignment for the extension power grasp 430 (see FIG. 4G) can include: VF1=[THUMB] and VF2-5=[INDEX, MIDDLE, RING, PINKIE].

An example virtual finger assignment for the palmar gutter power grasp 434 (see FIG. 4H) can include: VF2-5=[INDEX, MIDDLE, RING, PINKIE] and VF6=[PALM].

An example virtual finger assignment for the lateral prehension power grasp type 438 (see FIG. 4I) can include: VF1=[THUMB] and VF2-5=[INDEX, MIDDLE, RING, PINKIE].

An example virtual finger assignment for the writing tripod precision grasp type 442 (see FIG. 4J) can include: VF1=[THUMB], VF2=[INDEX], and VF3=[MIDDLE].

An example virtual finger assignment for the four-finger prismatic precision grasp 446 (see FIG. 4K) can include: VF1=[THUMB] and VF2-5=[INDEX, MIDDLE, RING, PINKIE].

An example virtual finger assignment for the disk precision grasp 454 (see FIG. 4L) can include: VF1=[THUMB], VF2=[INDEX], VF3-4=[MIDDLE, RING], and VF5=[PINKIE]. There is also the possibility of mapping the index, middle, ring, and pinkie fingers to one virtual finger.

An example virtual finger assignment for the tetrapod precision grasp 458 (see FIG. 4M) can include: VF1=[THUMB], VF2=[INDEX], VF3=[MIDDLE], and VF4=[RING].

An example virtual finger assignment for the tripod precision grasp type 462 (see FIG. 4N) can include: VF1=[THUMB], VF2=[INDEX], and VF3=[MIDDLE].

An example virtual finger assignment for the lateral pinch intermediate grasp 466 (see FIG. 4O) can include: VF1=[THUMB] and VF2=[INDEX].

An example virtual finger assignment for the bipod intermediate grasp 470 (see FIG. 4P) can include: VF2=[INDEX] and VF3=[MIDDLE].

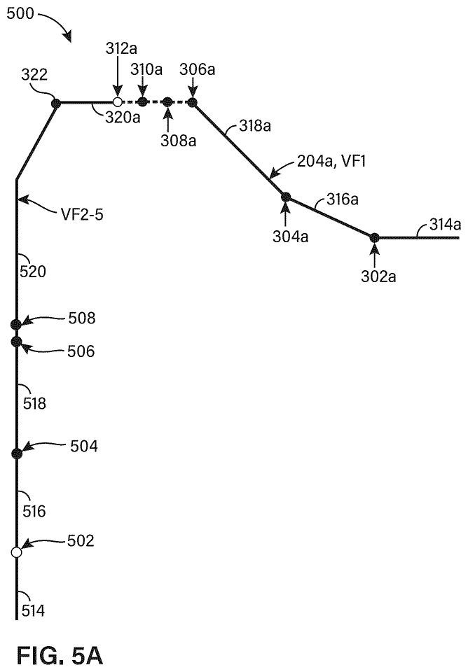

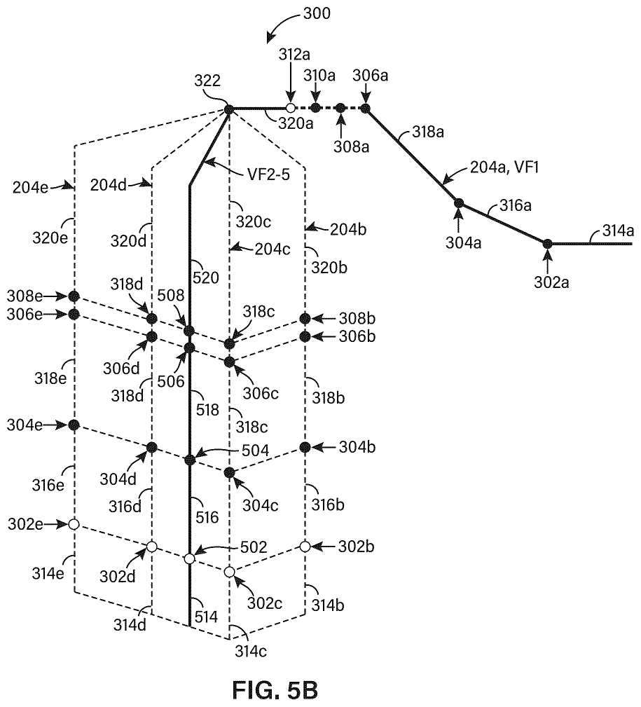

For illustrative purposes, FIG. 5A illustrates a kinematic structure 500 representing the virtual finger assignment for the large spherical power grasp 404 (see FIG. 4B). FIG. 5B shows the kinematic structure 500 relative to the kinematic structure 300 (see Example V and FIG. 3A) for the robotic hand 200. In FIG. 5A, the virtual finger VF1 represents the thumb 204a, and the virtual finger VF2-5 represents the index, middle, ring, and pinkie fingers 204b-e. The virtual finger VF6 is not shown in FIG. 5A because in this example the palm 202 does not have separate DOFs.

The virtual finger VF2-5 has joints and links that correspond to the joints and links of the index, middle, ring, and pinkie fingers 204b-e. For example, the virtual finger VF2-5 includes a virtual finger DIP joint having a virtual finger DIP flexion DOF 502, a virtual finger PIP joint having a virtual finger PIP flexion DOF 504, and a virtual finger MCP joint having a virtual finger MCP flexion DOF 506 and a virtual finger MCP abduction DOF 508. The virtual finger DIP flexion DOF 502 is formed between a virtual finger distal phalanx 514 and a virtual finger middle phalanx 516. The virtual finger PIP flexion DOF 504 is formed between the virtual finger middle phalanx 516 and a virtual finger proximal phalanx 518. The virtual finger MCP DOFs 506, 508 are formed between the virtual finger proximal phalanx 518 and a virtual finger MCP 520. The virtual finger MCP 520 is connected to the wrist joint 322. The positions of the joints/DOFs and links of the virtual finger VF1 can be the average of the positions of the corresponding joints/DOFs and links of the index, middle, ring, and pinkie fingers 204b-e.

The virtual finger assignment for the large spherical power grasp 404 reduces a five-finger physical hand to a two-finger virtual hand. Transformation of the hand between two configurations (e.g., an open hand configuration and a closed hand configuration) can involve control of two virtual fingers instead of five physical fingers. Movements in the virtual finger space can be transformed to the physical finger space based on the virtual finger assignment.

Kinematic structures such as shown in FIGS. 5A and 5B can be constructed for the other example virtual finger assignments. In some examples, some grasp types have the same virtual finger assignment (e.g., large spherical power grasp 404 and medium cylindrical wrap power grasp 414). In some examples, two virtual finger assignments can have the same number of virtual fingers but different DOF space configurations (e.g., small spherical power grasp 400 and ring power grasp 422). In other examples, grasp types can have virtual finger assignments that are different from the ones described herein (e.g., depending on hand control preferences or capabilities of the robotic hand).

### Example IX—Eigengrasp Space

The robotic hand 200 (see Example IV) has a high-dimensional joint space due to the large number of intrinsic DOFs in the hand (see Example V), which means that the set of all possible robotic hand configurations is very large, which can present challenges in finding stable grasp postures for a given object. A low-dimensional joint configuration space within which to search for stable grasp postures for particular grasp types can be defined. In some examples, the low-dimensional joint configuration space can be based on eigengrasps (see, for example, M. Ciocarlie, C. Goldfeder, and P. Allen, Dimensionality Reduction for Hand-Independent Dexterous Robotic Grasping, Proceedings of the 2007 IEEE/RSJ International Conference on Intelligent Robots and Systems, San Diego, CA, USA, Oct. 29-Nov. 2, 2007).

Eigengrasps are a set of basis vectors in the joint configuration space of a robotic hand. Eigengrasps can be linearly combined to form an eigengrasp space that approximates a grasp type. For a robotic hand having d DOFs, each eigengrasp is a d-dimensional vector representing a direction of motion in joint space. Each eigengrasp can be defined by an origin vector O and a direction vector D. Eigengrasps combined in an eigengrasp space have the same origin vector O. If a basis comprising n eigengrasps is chosen, a joint configuration space can be expressed as follows:

$$S = O + {\sum }_{i = 1}^{n} {e}_{i} {D}_{i}$$

where S is the state of the joint configuration, O is the origin vector, D is the direction vector, and e is a number representing a coordinate along the eigengrasp direction. The number e can be varied to adjust the state of the joint configuration.

Table 1 shows an example eigengrasp space (referred to herein as a semantic eigengrasp space for its generality).

TABLE 1

| name | origin | d₀ | d₁ | d₂ | d₃ | d₄ | d₅ |
|---|---|---|---|---|---|---|---|
| index finger MCP | 0.26 | 0.0 | 0.0 | 0.0 | 0.0 | 0.0 | 0.0 |
| abduction | | | | | | | |
| index finger MCP | 0.7 | 0.5 | 0.0 | 0.5 | 0.0 | 0.0 | 0.0 |
| flexion | | | | | | | |
| index finger PIP | 0.3 | 0.0 | 0.5 | 0.2 | 0.0 | 0.0 | 0.0 |
| flexion | | | | | | | |
| middle finger MCP | 0.0 | 0.0 | 0.0 | 0.0 | 0.0 | 0.0 | 0.0 |
| abduction | | | | | | | |
| middle finger MCP | 0.7 | 0.5 | 0.0 | 0.0 | 0.0 | 0.0 | 0.0 |
| flexion | | | | | | | |
| middle finger PIP | 0.3 | 0.0 | 0.5 | 0.0 | 0.0 | 0.0 | 0.0 |
| flexion | | | | | | | |
| ring finger MCP | −0.19 | 0.0 | 0.0 | 0.0 | 0.0 | 0.0 | 0.0 |
| abduction | | | | | | | |
| ring finger MCP | 0.7 | 0.5 | 0.0 | −0.2 | 0.0 | 0.0 | 0.0 |
| flexion | | | | | | | |
| ring finger PIP | 0.3 | 0.0 | 0.5 | −0.1 | 0.0 | 0.0 | 0.0 |
| flexion | | | | | | | |
| pinkie finger MCP | −0.26 | 0.0 | 0.0 | 0.0 | 0.0 | 0.0 | 0.0 |
| abduction | | | | | | | |
| pinkie finger MCP | 0.7 | 0.5 | 0.0 | −0.5 | 0.0 | 0.0 | 0.0 |
| flexion | | | | | | | |
| pinkie finger PIP | 0.3 | 0.0 | 0.5 | −0.2 | 0.0 | 0.0 | 0.0 |
| flexion | | | | | | | |
| thumb CMC | 0.78 | 0.0 | 0.0 | 0.0 | 0.0 | 0.0 | 0.0 |
| opposition | | | | | | | |
| thumb CMC | 0.4 | 0.0 | 0.0 | 0.0 | 0.2 | 0.0 | 0.0 |
| abduction | | | | | | | |
| thumb CMC flexion | 0.0 | 0.0 | 0.0 | 0.0 | 0.0 | 0.5 | 0.0 |
| thumb MCP flexion | 0.0 | 0.0 | 0.0 | 0.0 | 0.0 | 0.2 | 0.2 |
| thumb IP flexion | 0.2 | 0.0 | 0.0 | 0.0 | 0.0 | 0.1 | 0.1 |

In the example in Table 2, the name column shows labels for the active DOFs in the hand (e.g., the right hand), the origin column is a vector and includes a value for each of the active DOFs, and each of the d₀, d₁, d₂, d₃, d₄, and d₅ columns is a vector representing an eigengrasp. The semantic eigengrasp space can be expressed as follows:

$${S}_{semantic} = origin + {a}_{0} * {d}_{0} + {a}_{1} * {d}_{1} + {a}_{2} * {d}_{2} + {a}_{3} * {d}_{3} + {a}_{4} * {d}_{4} + {a}_{5} * {d}_{5}$$

By adjusting the parameters a₀, a₁, a₂, a₃, a₄, and as in the semantic eigengrasp space a variety of hand shapes can be formed.

The eigengrasp do has nonzero values for the MCP flexion DOFs of the index, middle, ring, and pinkie fingers. The eigengrasp d₀ allows flexion movement of the hand only at the MCP joints of the fingers.

The eigengrasp d₁ has nonzero values for the PIP flexion DOFs of the index, middle, ring, and pinkie fingers. The eigengrasp d₁ allows flexion movement of the hand only at the PIP joints of the fingers.

The eigengrasp d₂ has nonzero values for the MCP and PIP DOFs of the index, ring, and pinkie fingers. The eigengrasp d₂ allows flexion movements of the hand only at the MCP and PIP joints of the index, ring, and pinkie fingers.

The eigengrasp d₃ has a nonzero value for CMC abduction DOF of the thumb. The eigengrasp d₃ allows abduction movement of the hand only at the CMC joint of the thumb.

The eigengrasp d₄ has a nonzero value for the CMC flexion DOF, MCP flexion DOF, and IP flexion of the thumb. The eigengrasp d₄ allows flexion movements of the hand only at the CMC, MCP, and IP joints of the thumb.

In the illustrated example semantic eigengrasp, thumb opposition is fixed (e.g., none of the eigengrasps has a nonzero value for thumb CMC opposition DOF). In other examples, an additional eigengrasp can be defined that allows thumb opposition.

The semantic eigengrasp space involves some movement of all the fingers of the hand. However, it may be useful for some grasp types to define an eigengrasp space that involves movement of only some of the fingers.

Table 2 shows an example eigengrasp (referred to herein as tripod eigengrasp space) that approximates a tripod grasp type.

TABLE 2

| name | origin | d₀ | d₁ |
|---|---|---|---|
| index finger MCP abduction | 0.0 | 0.0 | 0.0 |
| index finger MCP flexion | 0.7 | 0.5 | 0.0 |
| index finger PIP flexion | 0.0 | 0.0 | 0.0 |
| middle finger MCP abduction | −0.12 | 0.0 | 0.0 |
| middle finger MCP flexion | 0.8 | 0.5 | 0.0 |
| middle finger PIP flexion | 0.0 | 0.05 | 0.0 |
| ring finger MCP abduction | −0.19 | 0.0 | 0.0 |
| ring finger MCP flexion | 1.5 | 0.0 | 0.0 |
| ring finger PIP flexion | 1.5 | 0.0 | 0.0 |
| pinkie finger MCP abduction | −0.26 | 0.0 | 0.0 |
| pinkie finger MCP flexion | 1.5 | 0.0 | 0.0 |
| pinkie finger PIP flexion | 1.5 | 0.0 | 0.0 |
| thumb CMC opposition | 0.78 | 0.0 | 0.0 |
| thumb CMC abduction | 0.084 | 0.0 | 0.0 |
| thumb CMC flexion | 0.0 | 0.0 | 0.5 |
| thumb MCP flexion | 0.0 | 0.0 | 0.0 |
| thumb IP flexion | 0.6 | 0.0 | 0.0 |

The tripod eigengrasp space can be expressed as follows:

$${S}_{tripod \_ flat} = origin + {a}_{0} * {d}_{0} + {a}_{1} * {d}_{1}$$

The eigengrasp do has nonzero values for the MCP flexion DOFs of the index and middle fingers and a nonzero value for the PIP flexion DOF of the middle finger. The eigengrasp d0 allows flexion movement of the hand at the MCP joints of the index and middle fingers and the PIP joint of the middle finger.

The eigengrasp d₁ has a nonzero value for the CMC flexion DOF of the thumb. The eigengrasp d1 allows flexion movement of the hand at the CMC joint of the thumb.

The tripod flat eigengrasp space involves movements of only the thumb, index, and middle fingers.

Other types of eigengrasp spaces that approximate particular grasp types can be defined generally as illustrated by the examples herein.

### Example X—System Implementing Grasp Generation

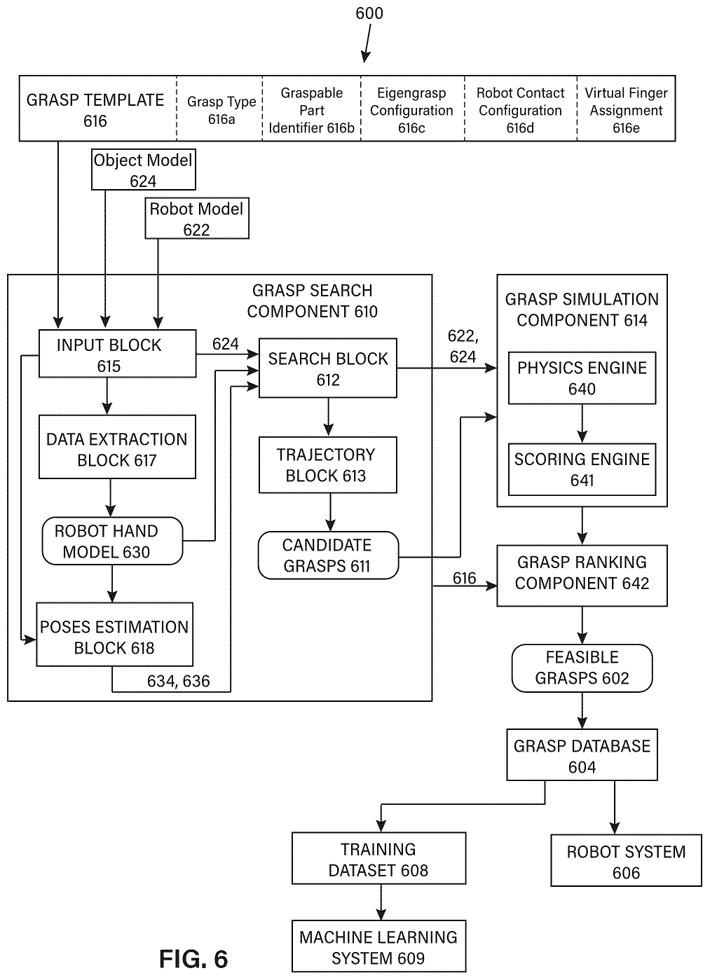

FIG. 6 is a block diagram of an example system 600 implementing grasp generation. Given a robotic hand and an object, the system 600 can generate a set of feasible grasps 602 that the robotic hand can use for stable grasping of the object. A feasible grasp 602 can include a pre-grasp posture and a post-grasp posture (see Example VII). The feasible grasp 602 may optionally include a grasp trajectory to transform the robotic hand between the pre-grasp posture and the post-grasp posture. The system 600 can store the feasible grasps 602 in a grasp database 604 in association with the robotic hand and the object (e.g., the metadata for the feasible grasps 602 can include identifiers of the robotic hand and object).

In some examples, a robot system 606 can access the grasp database 604 during task planning and select a feasible grasp 602 to use in completing a particular task. In other examples, a training dataset 608 for a machine learning system 609 can be generated using the feasible grasps 602 stored in the grasp database 604 along with information about the robotic hand and object associated with the feasible grasps 602. In some examples, the machine learning system 609 can learn to generate a set of feasible grasps for an arbitrary robotic hand and an arbitrary object using the training dataset 608.

The system 600 can include a grasp search component 610 that generates a set of candidate grasps 611 for a given robotic hand and a given object. The system 600 can include a grasp simulation component 614 that simulates grasping events using the candidate grasps 611 from the grasp search component 610. The system 100 can include a grasp ranking component 642 that generates the feasible grasps 602 based on the simulation results from the grasp simulation component 614.

Each candidate grasp 611 can include a candidate pre-grasp posture, a candidate post-grasp posture, a grasp trajectory, a stable object pose, and a hand pose. The grasp search component 610 can include a search block 612 that can search for robot hand configurations. The robot hand configurations can be used to generate candidate post-grasp postures for candidate grasps. The grasp search component 610 can include a trajectory block 613 that computes a candidate pre-grasp posture for a candidate post-grasp posture obtained from the search block 612. For a pair of candidate pre-grasp posture and candidate post-grasp posture, the trajectory block 613 can compute a grasp trajectory to transform a robotic hand between the candidate pre-grasp posture to the candidate post-grasp posture.

The grasp search component 610 can include an input block 615 that can accept input data for grasp generation and perform any necessary preprocessing of the input data. The input block 611 can accept a grasp template 616, a robot model 622, and an object model 624. In some examples, identifiers for the robot model 622 and the object model 624 can be specified in the grasp template 616. In some examples, path information that can be used to retrieve the object model and the robot model (e.g., from asset repositories) can be specified in the grasp template 616. In some examples, accepting the robot model 622 by the input block 615 can include retrieving the robot model 622 from a repository. In some examples, accepting the object model 624 by the input block 615 can include retrieving the object model 624 from a repository.

The grasp template 616 can specify one or more of a grasp type 616a, a graspable part 616b, an eigengrasp space configuration 616c, a robot contact configuration 616d, and a virtual finger assignment 616e. The graspable part identifier 616b can identify a target graspable part of the object model to use in searching for robot hand configurations. The grasp type 616a can identify the grasp type to use in grasping the target graspable part. The eigengrasp space identifier 616c can contain information to use in retrieving or generating a set of eigengrasps that can form an eigengrasp space (see Example IX) within which robot hand configurations having the grasp type 616a can be searched (e.g., the eigengrasp space can be generated based on the eigengrasp space configuration 616c). The robot contact configuration 616d can specify the parts of the robot model that are allowed to contact the target graspable part of the object in a grasping context. The virtual finger assignment 616e can specify a mapping of real physical fingers to virtual fingers that is compatible with the grasp type 616a (see Example VIII).

The following is an example of a grasp template 616 specifying a tripod grasp type:

```
robot:
  robot_id: robot_id
object:
  object_id: object_id
  graspable_part_id: graspable_part_id
grasp_type: tripod
eigengrasp:
  name: tripod
contacts:
  fingers:
    INDEX: &finger
    - DISTAL
    - MIDDLE
    MIDDLE: *finger
    RING: [ ]
    PINKIE: [ ]
    THUMB:
    - PROXIMAL
    - DISTAL
    PALM: false
virtual_fingers:
    - [INDEX]
    - [MIDDLE]
    - [THUMB]
```

In the example grasp template 616 specifying a tripod grasp type, the name of the grasp type is tripod, the name of the eigengrasp space is tripod (see Example IX), the robot contact configuration includes robot contacts on the distal and middle phalanxes of the index and middle fingers and on the proximal and distal phalanxes of the thumb, the virtual finger assignment includes mapping the index finger to a first virtual finger, mapping the middle finger to a second virtual finger, and mapping the thumb to a third virtual finger. In another example, a more general eigengrasp space, such as the semantic eigengrasp space described in Example IX, can be used instead of a tripod eigengrasp. The robot contacts will constrain the search for robot hand configurations to the portion of the eigenspace subspace containing a tripod grasp posture so that it is possible to use a more general eigengrasp space such as the semantic eigengrasp in the search.

The robot model 622 can include a robot identifier (or asset identifier) for a physical robot, a kinematic model of the physical robot, and metadata (see Example III). The metadata can contain additional information about the robot or about the kinematic model of the robot. The metadata can, for example, include information about the groupings of links and joints in the kinematic model that correspond to different parts of the robot (e.g., the links and joints that correspond to a left hand or a right hand of the robot). The robot model 622 can include a 3D representation of the robot expressed in any suitable geometry type (e.g., triangle mesh, point cloud, or voxel grid).

The object model 624 can include an object identifier (or an asset identifier) for the object, a 3D representation of the object expressed in any suitable geometry type (e.g., triangle mesh, point cloud, or voxel grid), and metadata (see Example VI). The metadata can include physical attributes of the object (e.g., weight and hardness of the object). The metadata can include symmetry properties of the object (e.g., whether the object exhibits rotational symmetry). The metadata can include mapping between graspable part identifiers and graspable parts of the object.

The grasp search component 610 can include a data extraction block 617 that can extract a hand (e.g., a right hand or a left hand) from the robot model 622 and output a robot hand model 630. In some examples, the data extraction block 617 can extract the hand by using the metadata associated with the robot model 622 to identify the group of joints (finger joints and wrist joint) that correspond to the target hand of the robot. The data extraction block 617 can use the identified group of joints identified from the metadata to extract a kinematic description of the hand from the robot model 622. For example, the identified group of joints, the links connected by the identified group of joints, and the actuators associated with the group of joints can be extracted from a kinematic description of the robot model 622. The data extraction block 617 can construct a robot hand model 630 using the data extracted from the robot model 622 for the target hand. The robot hand model 630 can include a kinematic model for the hand (e.g., written as a URDF model as described in Example III). The robot hand model 630 can include metadata for the kinematic model (e.g., written in XML format or as an SRDF model as described in Example III). The metadata model can, for example, indicate the joints and links in the kinematic description that belong to a particular finger.

The grasp search component 610 can include a pose estimation block 618 that can output a set of stable object poses 634 for the object model 624 and a set of hand poses 636 for each stable object pose 634. A stable object pose 634 is a stable resting pose of a given object (e.g., the object described in the object model 624) when the object is resting on a reference object ground (e.g., a flat surface). For some types of objects, there may be one stable pose. For other types of objects, there may be numerous stable object poses. A hand pose 636 describes a position and orientation of the hand that can allow the hand to grasp the object in the stable object pose.

In some examples, the stable object poses 634 can be generated using the 3D representation of the object included in the object model 624. An example of a software library that can be used to generate stable object poses is TRIMESH. TRIMESH includes a poses module and a compute_stable_poses function within the “poses” module that can accept a mesh (e.g., a triangle mesh) as an input and generate stable resting poses of the mesh on a planar surface.

For objects that are rotationally symmetric (e.g., a ball), TRIMESH or other similar software can output numerous stable object poses that are rotationally symmetric. In some examples, the pose estimation block 618 can generate a filtered set of stable object poses that takes into account object symmetry. For example, the pose estimation block 618 can receive a first set of stable object poses as input and generate clusters of stable object poses from the first set of stable object poses. The first set of stable object poses can be the output of TRIMESH or other software library that generates stable object poses generally without taking into account object symmetry. The pose estimation block 618 can group the stable object poses in the first set of stable object poses that are the same under rotational symmetry into the same cluster. The pose estimation block 618 can then select one example stable object pose from each cluster to form the filtered set of stable object poses. The filtered set of stable object poses can be used as the set of stable object poses 634 that is outputted by the pose estimation block 618.

The pose estimation block 618 can generate a set of hand poses 636 for each stable object pose 634. In some examples, the pose estimation block 618 can create a set of points that covers the space of all possible hand poses using a sampling algorithm such as super-Fibonacci algorithm. The set of points can be approximately equally distributed points over the space of all possible hand poses. The pose estimation block 618 can select the hand poses where the palm of the hand (from the robot hand model 630) is oriented toward a reference ground plane as candidate hand poses. For a given stable object pose 634, the orientations of the candidate hand poses can be multiplied with the orientation of the reference object ground for the given stable object pose 634 to obtain a set of hand poses 636 for the given stable object pose 634.

The input data for the search block 612 can include the hand poses and the stable object poses from the pose estimation block 618, the robot hand model 630, the robot contact configuration 616d, the object model 624, the graspable part identifier 616c, and the eigenspace configuration 616c. The search block 612 can generate robot hand configurations based on the input data.

In some examples, the search block 612 can attach the robot contacts from the robot contact configuration 616d to the robot hand model 630 (e.g., identify the links of the robot hand model 630 that correspond to the robot contacts specified in the robot contact configuration 616d). The search block 612 can attach a target graspable part to the object model 624 based on the graspable part identifier (e.g., identify the subset of the 3D representation of the object model 624 that corresponds to the target graspable part identifier 616c).

The search block 612 can populate a search environment using the robot hand model 630 with the robot contacts and the object model 624 with the target graspable part. For each given combination of stable object pose 634 and hand pose 636, the search block 612 can position the object model 624 in the search environment with the given stable object pose 634 and can position the robot hand model 630 in the search environment with the given hand pose. The search block 612 can adjust the joint/DOF values in the robot hand model 630 to find robot hand configurations that can form stable grasps. The search block 612 can search for robot hand configurations based on a set of grasp quality metrics (e.g., contact energy, force-closure, object penetration, and/or self-collision of the robot). For illustration purposes, each grasp quality can have a value ranging from 0 to 1 and a cutoff value within the range. During the search for robot hand configurations, the robot hand configurations with quality values above the cutoff value for one or more of the grasp quality metrics in the set of grasp quality measures may be discarded. The search block 612 may compute a quality score for each robot hand configuration not discarded based on the quality values of the robot hand configuration for the set of grasp quality metrics (e.g., using a score formula based on a weighted sum of the grasp quality metrics). The quality score can be based on any suitable scale (e.g., 0 to 1, with 0 being lowest quality and 1 being highest quality).

Contact energy quantifies the degree of closeness of the robot contacts to the target graspable part of the object. The closer the robot contacts are to the target graspable part, the lower the contact energy. The search in search block 612 can include adjusting the joint/DOF values to find robot hand configurations that produce contact energies in the neighborhood of zero. In some examples, the search block 612 can use GRASPIT! grasp simulator to search for robot hand configurations based on minimizing contact energy. GRASPIT! uses simulated annealing to minimize contact energy between the robot and the object.

A grasp can be characterized by forces/torques acting on the object at each contact point (between the robot and the object). A grasp is force-closure if it is possible to apply forces/torques at the contact points such that any external force and torque applied to the object can be balanced. The force and torque at each contact point can be assumed to have an adjustable magnitude but fixed direction, which gives adjustable weights that can be multiplied with force/torque at each point. A frictionless force-closure property means that the weights can be selected such that the total vector force/torque is zero. The search in the search block 612 can include adjusting the joint/DOF values and weights applied at the contact points (between the robot contacts and the target graspable part) to find robot hand configurations that produce total force/torque (weighted sum of the forces/torques produced at the contact points) in the neighborhood of zero. The search block 612 can include a first search step based on adjusting joint/DOF values to produce robot hand configurations that minimize contact energy. The search can include a second search step based on adjusting the weights applied at the contact points of the robot hand configurations from the first search step to produce robot hand configurations that minimize total force/torque.

Searching based on collision can adjust the joint/DOF values to avoid penetration of the robot fingers into the object and to avoid collision of the robot hand model with itself. In some examples, the search block 612 can perform collision checks while searching for robot hand configurations based on minimizing contact energy and/or minimizing total force/torque at contact points and use the collision checks to eliminate robot hand configurations from further consideration.

The search block 612 can produce one or more post-grasp robot hand configurations for each given combination of stable object pose 634 and hand pose 636. The search block 612 can rank the post-grasp robot hand configurations based on one or more grasp quality metrics (e.g., contact energy, force-closure, object penetration, and/or robot self-collision). The search block 612 can create a set of candidate grasps 611 based on the top-ranking post-grasp robotic hand configurations. The search block 612 can populate each candidate grasp 611 with a candidate post-grasp posture (provided by a top-ranking post-grasp robotic hand configuration), a hand pose (provided by the top-ranking post-grasp robotic hand or the given hand pose), and a stable object pose (provided by the given stable object pose). The hand pose of the post-grasp robotic hand configuration can be the same as the given hand pose (e.g., if the hand pose is not optimized as part of the search) or can be different from the given hand pose (e.g., if the position and orientation of the hand are adjusted during the search).

The trajectory block 613 can receive a set candidate grasps 611 with the post-grasp data from the search block 612. For each candidate grasp 611, the trajectory block 613 can determine a candidate pre-grasp posture and a grasp trajectory to transform the robotic hand from the candidate pre-grasp posture to the candidate post-grasp posture of the candidate grasp.

In some examples, for each given candidate post-grasp posture, the trajectory block 613 can determine a closed hand posture that is more closed compared to the candidate post-grasp posture. The trajectory block 613 can determine a closing motion of a grasp trajectory to transform the candidate post-grasp posture to the closed hand posture. The trajectory block 613 can back-extrapolate the closing motion to obtain a candidate pre-grasp posture that is more open compared to the candidate post-grasp posture. In some examples, the trajectory block 613 can determine the closing motion based on the virtual finger assignment 616e using the method described in Example XIII.

The trajectory block 613 can update each candidate grasp 611 with the candidate pre-grasp posture and grasp trajectory and output the set of candidate grasps 611. For each given stable pose and hand pose, a set of candidate grasps 611 can be outputted. Each candidate grasp 611 can include a candidate post-grasp posture (from a top-ranking post-grasp robot hand configuration found in the search block 612), a hand pose (from the top-ranking post-grasp robot hand configuration or the given hand pose), a candidate pre-grasp posture determined by the trajectory block 613 based on the candidate post-grasp posture, a grasp trajectory determined by the trajectory block 613 to transform the robotic hand between the candidate pre-grasp posture and the candidate post-grasp posture, and the given stable object pose.

The grasp simulation component 614 can receive a set of candidate grasps 611 from the grasp search component 610 (or from the trajectory block 613) as input. The grasp simulation component 614 can receive (or access) the robot hand model 630 and the object model 624 from the grasp search component 610 (e.g., from the search block 612). The grasp simulation component 614 includes a physics engine 640 that can simulate grasping of an object by the robot hand with a given candidate grasp under physics conditions. Any suitable physics engine can be used. Examples of suitable physics engines are Omniverse Isaac Gym and MuJoCo. The grasp simulation component 614 can include a scoring engine 641 that can compute a grasp stability score for each simulation of the given candidate grasp.

For each simulation of a given candidate grasp in the physics engine 640, a simulated grasp can be generated that is identical to the given candidate grasp or that is an adjusted version of the given candidate grasp (e.g., a version of the given candidate grasp in which the DOFs of the candidate post-grasp posture have been adjusted to increase the closeness of the robotic fingers to the object). The simulated grasp can be executed in the physics engine 640 to cause the robotic hand to grasp the object. Execution of the simulated grasp can include positioning the robotic hand in the hand pose indicated in the simulated grasp, positioning the object in the stable object pose indicated in the simulated grasp, and transforming the robotic hand from the candidate pre-grasp posture indicated in the simulated grasp to the candidate post-grasp posture indicated in the simulated grasp using the grasp trajectory indicated in the simulated grasp. After the simulated grasp is executed, a wrench disturbance (an external force or torque, or a combination thereof) can be applied to the object to assess the stability of the simulated grasp. In some examples, the displacement of the object in response to the wrench disturbance is measured.

The grasp simulation component 614 can include a scoring engine 641 that computes a grasp stability score for a simulated grasp based on the displacement of the object in response to the wrench disturbance applied to the object after execution of the simulated grasp. The scoring engine 641 can use any scoring scheme that penalizes nonzero displacements of the object in response to applied wrench disturbance (see Example XI).

The grasp ranking component 642 can receive simulated grasps and respective score data from the grasp simulation component 614 (e.g., from the scoring engine 641). The grasp ranking component 642 can rank the simulated grasps based on the grasp stability scores, and further based on the wrench disturbance applied to the simulated grasps. For each target wrench disturbance, the grasp ranking component 642 can select the simulated grasps having individual grasp stability scores above a grasp stability score threshold and use the selected simulated grasps to generate the feasible grasps 602 (see Example XI).

The feasible grasp 602 generated based on a selected simulated grasp can include a pre-grasp posture (based on the candidate pre-grasp posture of the selected simulated grasp), a post-grasp posture (based on the candidate post-grasp posture of the selected simulated grasp, which may be adjusted compared to the original candidate post-grasp posture form which the selected simulated grasp was generated), a stable object pose of the selected simulated grasp, and a hand pose of the selected simulated grasp. The feasible grasp 602 can optionally include the grasp trajectory of the simulated grasp. The feasible grasp (or metadata for the feasible grasp) can include the grasp stability score assigned to the selected simulated grasp, the wrench disturbance applied to the simulated grasp. The feasible grasp (or metadata for the feasible grasp) can include the grasp template 616 or information from the grasp template (e.g., the grasp type and identifying information for the robot model 622 and object model 624).

The system components 610, 614, 642 can form a pipeline (e.g., each of the system components 610, 614, 642 can be a processing block, where the output of the system component 610 is piped to the input of the system component 614, and the output of the system component 614 is piped to the input of the system component 642). The system components 610, 614, 642 can be implemented in any combination of hardware, software, or firmware. The system components 610, 614, 642 or processing blocks implemented therein can be stored in one or more computer-readable storage media or computer-readable storage devices and executed by one or more processor units. The blocks illustrated in FIG. 6 can be generic to the specifics of operating systems or hardware and can be applied in any variety of environments to take advantage of the described features.

### Example XI—Method Implementing Grasp Generation

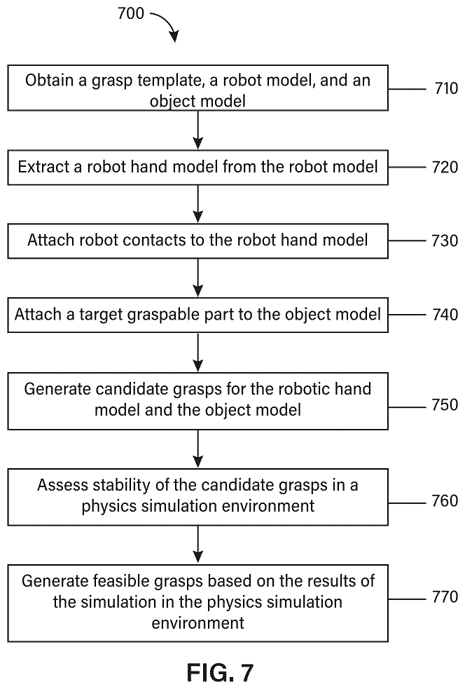

FIG. 7 is a flowchart of an example method 700 of grasp generation for a robotic hand. Given a robot hand model for the robotic hand and an object model for an object, the method 700 can generate feasible grasps that the robotic hand can use to stably grasp the object. The method 700 can be practiced using the system 600 described in FIG. 6 (see Example X).

At 710, the method 700 can include obtaining a grasp template, a robot model, and an object model. In some examples, the grasp template, the robot model, and the object model can be provided in a request for grasp generation for a robotic hand. In some examples, the grasp template can specify identifiers for the robot model and object model. In some examples, the identifiers can be used to retrieve the robot model and object model from asset repositories.

The grasp template contains information to use in grasp generation (see grasp template 616 in Example X and FIG. 6). For example, the grasp template can specify a grasp type. The grasp template can include a robot contact configuration specifying robot contacts to associate with a robot hand model. The grasp template can specify a graspable part identifier that can be used to identify a target graspable part of an object model to grasp with the grasp type. The grasp template can include an eigengrasp space identifier that can be used to obtain or generate a set of eigengrasps that define an eigengrasp space from which robot hand configurations can be searched. The grasp template can specify a virtual finger assignment for a robotic hand.

The robot model can include a kinematic description of a robot having at least one robotic hand and metadata (see Example X). The metadata can group joints in the robot model into semantic units and include other robot configuration data. The identifier of the robot model can match a robot model identifier specified in the grasp template.

The object model can include a 3D representation of an object having at least one graspable part and metadata (see Example X). The metadata can identify each subset of the 3D representation in the object model that corresponds to a graspable part. The metadata can associate a graspable part identifier with each subset of the 3D representation corresponding to a graspable part. The metadata can include other attributes of the object (e.g., physical attributes of the object such as dimensions, weight, hardness, and rotational symmetry). The identifier of the object model can match an object model identifier specified in the grasp template.

At 720, the method can include extracting a robot hand model from the robot model. For example, the metadata for the robot model can be used to identify a portion of the robot model describing a target robotic hand (e.g., a left hand or a right hand). The method can include extracting the identified portion of the robot model and using the extracted portion of the robot model to construct a kinematic description of a robotic hand. In some examples, the kinematic description can be written using URDF. The method can include generating metadata to accompany the kinematic description. For example, the metadata can group joints and links into semantic units (e.g., thumb, index finger, middle finger, ring finger, pinkie, palm, and wrist joint). In some examples, the metadata can be written using SRDF. A robot hand model can be generated that includes the kinematic description of the robotic hand extracted from the robot model and the metadata associated with the kinematic description of the robotic hand.

At 730, the method can include attaching the robot contacts to the robot hand model. The robot contacts can be the parts of the robotic hand (or links in the robot hand model) that are allowed to touch an object when the robotic hand grasps the object. For example, for a “tripod” grasp type, the robot contact configuration can indicate robot contacts that include only the distal phalanxes of the thumb, index, and middle fingers. The robot contacts can be obtained from the robot contact configuration specified in the grasp template. The robot contacts can be attached to the robot hand model by updating the metadata for the robot hand model to include the specified robot contact configuration or by other method of associating the contact data with the robot hand model.

At 740, the method can include attaching a target graspable part to the object model. The object model can have one or more graspable parts. In some examples, the metadata for the object model can indicate the graspable parts with identifiers. In some examples, a graspable part in the metadata can have an “active” attribute that can be turned on or off. Attaching the target graspable part to the object model can include finding the graspable part in the metadata having an identifier that matches the identifier specified in the grasp plate and turning on the active attribute of the matching graspable part or otherwise identifying the matching graspable part as the target graspable part.

At 750, the method can include generating candidate grasps for the robotic hand model and the object model. In operation 750, the method can include determining a set of stable object poses for the object model. The method can include determining a set of hand poses for each stable object pose (the term “hand pose” refers to position and orientation of the robotic hand). The method can include searching within a configuration space (or within a subspace of the configuration space) of the robotic hand model for a post-grasp robotic hand configuration that can engage the object for each given combination of stable object pose and hand pose. The post-grasp robotic hand configuration includes a hand posture (or finger configuration) and a hand pose. In some examples, the hand pose of the robotic hand configuration found in the search can be the given hand pose. In other examples, the search for the robotic hand configuration can include a search for a hand pose (e.g., the DOFs that control the hand pose of the robotic hand can be adjusted during the search). A candidate grasp can be generated that includes the hand posture of the robotic hand configuration found in the search as a candidate post-grasp posture. The method can include generating an candidate pre-grasp posture to associate with the candidate post-grasp posture in the candidate grasp. The method can include generating a grasp trajectory to transform the robotic hand from the candidate pre-grasp posture to the candidate post-grasp posture for the candidate grasp. For each given combination of stable object pose and hand pose, operation 750 can output a candidate grasp that includes a candidate post-grasp posture, a candidate pre-grasp posture, a grasp trajectory, a stable object pose, and a hand pose.

A stable object pose is a stable resting pose of a given object when the object is resting on a reference object ground. The stable object pose includes position and orientation information relative to the reference object ground. A stable object pose can be obtained from the object model using, for example, a software library such as TRIMESH. In some examples, a software library used in generating stable object poses may not take into account object symmetry and may output more stable object poses than necessary for grasp generation. In some examples, the method can include applying a filtering function to a set of stable objects outputted by a software library to obtain a filtered or reduced set of stable object poses that takes into account object symmetry. In some examples, the filtering function be a clustering function that groups stable object poses that are the same under rotational symmetry into the same cluster. The filtering function can select a representative stable object pose from each cluster and generate a filtered or reduced set of stable object poses from the representative stable object poses (see Example X).

A hand pose for a stable object pose specifies a position and orientation of the robotic hand relative to the object at the stable object pose. The hand pose is a pose that can allow the robotic hand to grasp the object in the stable object pose. In some examples, a set of hand poses for a given stable object pose can be generated by creating a uniform grid that covers the space of all possible hand poses and sampling the space using a sampling algorithm such as super-Fibonacci algorithm. In some examples, the samples obtained from the hand pose space correspond to the hand poses where the palm of the hand is oriented towards a reference ground plane. The reference ground plane can be mapped to the reference object ground for a final set of hand poses to associated with the given stable object pose.

The method can include creating a search environment for each given combination of stable object pose and hand pose. In the search environment, the object model can be positioned according to the given stable object pose, and the robot hand model can be positioned according to the given hand pose. The search environment is an environment in which the DOFs of the robot hand model (e.g., the finger DOFs) can be adjusted to change the robot hand configuration. In some examples, the search environment can be created using an interactive grasp simulator tool such as Grasplt!.

The configuration space of the robot hand model is the set of all possible robot hand configurations. The dimension of the configuration space of the robot hand model is the minimum number of DOFs needed to completely specify the robot hand configuration. In some examples, since the configuration space of the robot hand model can be very large, the method can include constraining the search for a post-grasp robot hand configuration to a subspace of the configuration space. In some examples, the subspace is an eigengrasp space defined by a set of eigengrasps (see Examples IX and X). The set of eigengrasps used in the search can be generated or obtained, for example, using the eigengrasp information specified in the grasp template.

In some examples, searching for post-grasp robot hand configurations within the configuration space or within the eigengrasp space can include searching for robot hand configurations based on a set of grasp quality metrics (e.g., one or more of contact energy, force-closure, object penetration, or self-collision; see Example X).

In some examples, the method can include assigning a grasp quality score to each post-grasp robot hand configuration found in the search based on the quality values of the post-grasp robot hand configuration for the set of grasp quality metrics. The grasp quality score can reflect the quality of each post-grasp robot hand configuration compared to the other post-grasp robot hand configurations. The method can include ranking the post-grasp robot hand configurations found for each given combination of stable object pose and hand pose based on the grasp quality score and selecting the top-ranking robot hand configurations (e.g., the top 25% of the post-grasp robot hand configurations) for generation of candidate grasps.

Each selected post-grasp robot hand configuration provides a candidate post-grasp posture and a hand pose at a stable object pose for a candidate grasp. The method can include determining a candidate pre-grasp posture to associate with the candidate post-grasp posture and a grasp trajectory to transform the candidate pre-grasp posture to the candidate post-grasp posture, and vice versa.

In one example, a method for determining the candidate pre-grasp posture and grasp trajectory for a given post-grasp robot hand configuration can include determining a closed robot hand configuration that is more closed compared to the given post-grasp robot hand configuration. A closing motion that can transform the given post-grasp robot hand configuration to the closed robot hand configuration can be determined and used to generate the grasp trajectory. In some examples, the closing motion can be determined using the method described in Example XIII. The grasp trajectory determined based on the closing motion can be back-extrapolated to an open hand configuration that is more open compared to the given post-grasp robot hand configuration. The hand posture of the open hand configuration can be used as the candidate pre-grasp posture to associate with the candidate post-grasp posture of the given robot hand configuration.

In another example, the method for determining the candidate pre-grasp posture and grasp trajectory for a given post-grasp robot hand configuration can include selecting a grasp from a library of grasps and using the pre-grasp posture from the selected grasp as the candidate pre-grasp posture to associate with the candidate post-grasp posture of the given post-grasp robot hand configuration. For example, a grasp having the same grasp type as the grasp type specified in the grasp template and that has a pre-grasp posture that is more open compared to the candidate post-grasp posture of the given robot hand configuration can be selected. The method can include determining an opening motion that can transform the candidate post-grasp posture to the candidate pre-grasp posture (i.e., the pre-grasp posture from the grasp selected from the library of grasps) and generating the grasp trajectory based on the opening motion.

For each given combination of stable object pose and hand pose, a plurality of post-grasp robot hand configurations can be found by searching within the configuration space (or within a subspace of the configuration space, e.g., an eigengrasp space) of the robot hand model. For each post-grasp robot hand configuration selected for generating a candidate grasp, a candidate pre-grasp posture and a grasp trajectory to associate with the candidate post-grasp posture of the post-grasp robot hand configuration can be generated. For each given combination of stable object pose and hand pose, one or more candidate grasps can be generated. Each candidate grasp can include a candidate post-grasp posture, a candidate pre-grasp posture, a grasp trajectory to transform the candidate pre-grasp posture to the candidate post-grasp posture, a stable object pose, and a hand pose.

At 760, the method can include assessing the stability of the candidate grasps in a physics engine. For each given candidate grasp, the method can include performing a plurality of simulation events in the physics engine, assigning a score to the given candidate grasp for each simulation event, and storing the simulation data for later use in generating feasible grasps and/or preparing a training dataset for a machine learning system.

For each simulation event for a given candidate grasp, the method can include generating a simulated grasp based on the given candidate grasp. The parameters of the simulated grasp can be the same as the parameters of the given candidate grasp (e.g., the simulated grasp can have a simulated post-grasp posture, a simulated pre-grasp posture, a grasp trajectory, a stable object pose, and a hand pose). The parameter values of the simulated grasp can be identical to the parameter values of the given candidate grasp, or one or more parameter values of the simulated grasp can differ from the corresponding one or more parameters of the given candidate grasp (e.g., the simulated grasp can be an adjusted version of the given candidate grasp).

For each simulation event, the method can include executing the simulated grasp generated for the simulation event in the physics engine. The execution can include positioning the robot hand model at the simulated pre-grasp posture indicated in the simulated grasp and positioning the object model at the stable object pose indicated in the simulated grasp in the physics engine. The method can include causing the robot hand to grasp the object by transforming the robot hand model from the simulated pre-grasp posture to the simulated post-grasp posture indicated in the simulated grasp using the grasp trajectory indicated in the simulated grasp.

After executing the simulated grasp in the simulation event, while the robot hand model is in the simulated post-grasp posture, the method can include applying a wrench disturbance (e.g., an external force or torque) to the object model. After applying the wrench disturbance, a response of the object model to the applied wrench disturbance is measured. In some examples, the response of the object that is measured is the displacement of the object (e.g., changes in the position and orientation of the object from the initial position and orientation before the wrench disturbance is applied; the initial position and orientation can be the stable object pose indicated in the simulated grasp).

The method can include assigning a score to the simulated grasp based on the response (e.g., displacement) of the object model to the applied wrench disturbance. In some examples, the score assigned to the simulated grasp can be determined using any score scheme that penalizes nonzero displacements of the object model in response to an applied wrench disturbance. One example of a score formula that can be used to compute a score for a simulation event is given by the following expression:

$$Q = exp ( - a \cdot Δ P - b \cdot Δ O ) \qquad ( 1 )$$

In Equation (1), Q is score, ΔP is change in position of the object model from an initial position, ΔO is change in orientation of the object model from an orientation, and a and b are weights. The initial position and initial orientation can be the position and orientation of the object model prior to applying the wrench disturbance. The values of Q can range from 0 to 1. When both ΔP and ΔO are zero (i.e., object displacement is zero), the value of Q is 1. The simulated grasp has the highest stability when the value of Q is 1, and the degree of stability of the simulated grasp decreases as Q decreases.

In some examples, a first set of simulation events can be performed in the physics engine for a given candidate grasp. The simulated grasps generated for the simulation events of the first set are identical to the given candidate grasp, but the wrench disturbance applied in the simulation events of the first set can be varied across the set. For example, the wrench disturbance applied in a first simulation event can be different from a wrench disturbance applied in a second simulation event. This procedure can allow exploration of the stability of the given candidate grasp under different wrench disturbance conditions. For example, the score data can be examined to determine the minimum wrench disturbance and the maximum wrench disturbance for which the given candidate grasp is stable (or has a score above a score threshold).

In some examples, a second set of simulation events can be performed in the physics engine for the given candidate grasp. The simulated grasps generated for the simulation events of the second set can be adjusted versions of the given candidate grasp, and the wrench disturbance applied in the simulation events of the second set can be a target wrench disturbance. An adjusted version of the given candidate grasp can include adjustments to the DOFs of the robot hand model (e.g., to increase the closeness of the robot fingers to the object), which means, for example, that the parameter values for the simulated post-grasp posture can be different from the parameter values for the given candidate grasp underlying the simulated grasp. This procedure allows refinements to the given candidate grasp that can push the given candidate grasp from a grasp that has relatively low stability at a target wrench disturbance to a grasp that has relatively high stability at a target wrench disturbance. For example, if the results of the first set of simulation events reveal a simulated grasp with a score that is below but close to a score threshold for a target wrench disturbance, it may be possible to adjust the simulated grasp to increase the score of the simulated grasp for the target wrench disturbance. In some examples, the second set of simulation events can be performed in parallel with the first set of simulation events.

For each given candidate grasp, the simulation data can be stored. For each simulation event, the stored simulation data can include the parameters of the simulated grasp (e.g., simulated post-grasp posture, simulated pre-grasp posture, grasp trajectory, stable object pose, and hand pose of the simulated grasp). The parameter values of the simulated grasp can be identical to the parameter values of the given candidate grasp or can differ from the parameter values of the given candidate grasp (e.g., if the simulated grasp is an adjusted version of the given candidate grasp). The stored simulation data can include the wrench disturbance applied in the simulation event and the score assigned to the simulated grasp in response to the applied wrench disturbance. The stored data can include an identifier of the given candidate grasp or can be otherwise associated with the given candidate grasp.

At 770, the method can include generating feasible grasps based on the simulation results from operation 760. For each given candidate grasp, the method can include selecting the simulated grasps having a score above a score threshold at a target wrench disturbance. The method can include generating feasible grasps from the simulated grasps. A feasible grasp can include the simulated pre-grasp posture of the respective simulated grasp as a pre-grasp posture, the simulated post-grasp posture of the respective simulated grasp as a post-grasp posture, the stable object pose of the respective simulated grasp, and the hand pose of the respective simulated grasp. The feasible grasp can optionally include the grasp trajectory from the respective simulated grasp (in some examples, the grasp trajectory can be computed on the fly such that it is not necessary to include the grasp trajectory in the feasible grasp). Metadata for the feasible grasp can include the score of the corresponding simulated grasp and the wrench disturbance applied to the simulated grasp to generate the score. Metadata for the feasible grasp can include information from the grasp template (e.g., the robot model identifier, the object model identifier, the graspable part identifier, and the grasp type).

The feasible grasps and metadata can be stored in a grasp database. In some examples, a robot system can access the grasp database and search for a feasible grasp to use during task planning.

### Example XII—Method Implementing Training Dataset Generation

A method of generating a training dataset for a machine learning algorithm can include repeating method 700 (Example XI) for different combinations of robot models (or robot hand models) and object models. The training dataset can be generated from the stored simulation data in operation 760 of the method 700 (see Example XI) for the different combinations of robot models and object models. The training dataset can be used to train a machine learning algorithm to automatically generate feasible grasps given an arbitrary robot model and an arbitrary object model as inputs.

### Example XIII—Method of Generating Closing Motion of a Grasp Trajectory

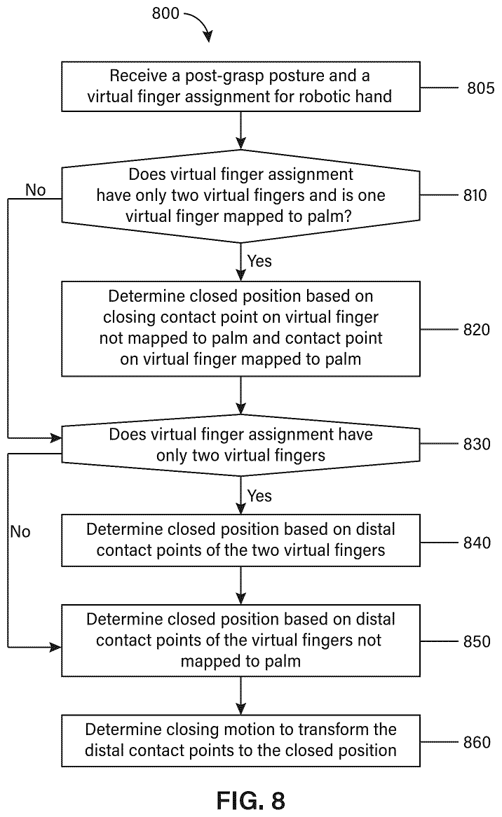

FIG. 8 illustrates an example method 800 of generating a closing motion of a grasp trajectory. In some examples, the method 800 can be implemented in the grasp trajectory block 613 (see Example X) and used in operation 750 of the method 700 (see Example XI).

Given a post-grasp posture and a virtual finger assignment for a robotic hand based on a grasp type, the method 800 can determine a closing motion to transform the robotic hand from the post-grasp posture to a closed hand posture that is more closed compared to the post-grasp posture. In one example, the physical fingers of the robotic hand can be mapped to virtual fingers using the virtual finger assignment (see Example VIII). In one example, the closing motion can be determined by finding a closed position within a finger volume formed by the post-grasp posture and determining a closing motion to move contact points on the virtual fingers from the post-grasp posture to the closed hand posture. To fully define the robot hand configuration, the hand pose can be the same at the post-grasp posture and the closed hand posture.

At 805, the method can include receiving a post-grasp posture and a virtual finger assignment for a robotic hand based on a grasp type. For example, the post-grasp posture can be from a candidate grasp generated by the search block 612 (see Example X) or generated in operation 750 of the method 700 (see Example XI), and the virtual finger assignment can be the virtual finger assignment 616e specified in the grasp template 616 (see Example X) or the grasp template in operation 710 of the method 700 (see Example XI). The method can also include receiving the hand pose, which can be used together with a hand posture to configure the robotic hand.

At 810, the method can include determining whether the virtual finger assignment has only two virtual fingers and whether one of the two virtual fingers is mapped to a palm. If the virtual finger assignment has only two virtual fingers and one of the virtual fingers is mapped to a palm (or includes a palm), the method continues at 820. If the virtual finger assignment does not have only two virtual fingers or if the virtual finger assignment has only two virtual fingers and one of the two virtual fingers is not mapped to a palm (or does not include a palm), the method continues at 830.

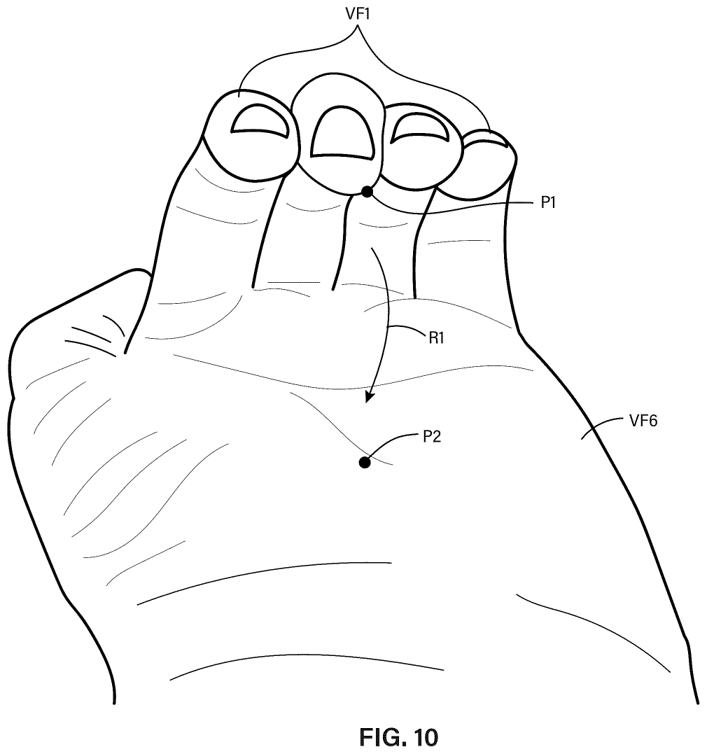

At 820, the method has determined that the virtual finger assignment has only two virtual fingers and that one of the virtual fingers is mapped to a palm. Let VF1 be the virtual finger that is not mapped to the palm, and let VF6 be the virtual finger that is mapped to a palm (or that includes a palm) (see FIG. 10). The method includes determining a first closing contact point for VF1 and a second closing contact point for VF6 (see, e.g., contact point P1 on VF1 and contact point P2 on VF6 in FIG. 10). In one example, the palm does not have DOFs and is stationary when transforming the virtual fingers from the post-grasp robot hand configuration (or post-grasp posture) to the closed robot hand configuration (or closed hand posture). In this case, the closed position can be a point on VF6. For example, the closed position can be the same as the second closing contact point on VF6. The first closing contact point on VF1 can be any point on VF1 that contacts the second closing point on VF6 when VF1 is rotated towards VF6 (e.g., rotated in the direction R1 shown in FIG. 10). The first closing contact point on VF1 and the second contact point on VF6 can be determined based on the design of the robotic hand (e.g., the relation between the robotic finger(s) mapped to VF1 and the palm mapped to VF6). The method continues at 860.

At 830, the method has determined that the virtual finger assignment does not have only two virtual fingers or that the virtual finger assignment has only two virtual fingers and one of the two virtual fingers is not mapped to a palm. The method determines if the virtual finger assignment has only two virtual fingers. If the virtual finger assignment has only two virtual fingers, the method continues at 840. If the virtual finger assignment has more than two virtual fingers, the method continues at 850.

At 840, the method has determined that the virtual finger assignment has only two virtual fingers and one of the two virtual fingers is not mapped to a palm. Let VF1 be one of the virtual fingers, and let VF2 be the other of the virtual fingers. The method includes determining a first closing contact point for VF1 and a second closing contact point for VF2. The first closing contact point for VF1 can be a contact point on a distal phalanx of the robotic finger mapped to VF1. The second closing contact point for VF2 can be a distal phalanx of the robotic finger mapped to VF2. The method includes finding an intermediate point between the first closing contact point and the second closing contact point and using the intermediate point as the closed position within the grasp volume. The method continues at 860.

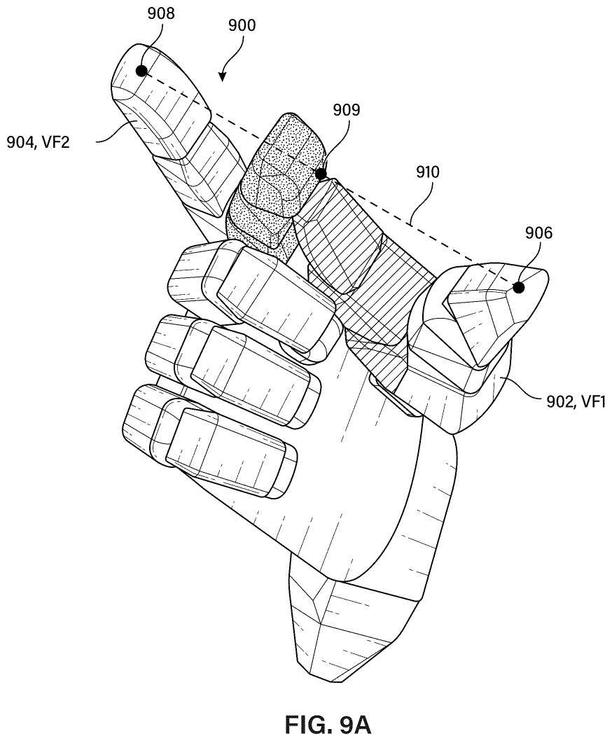

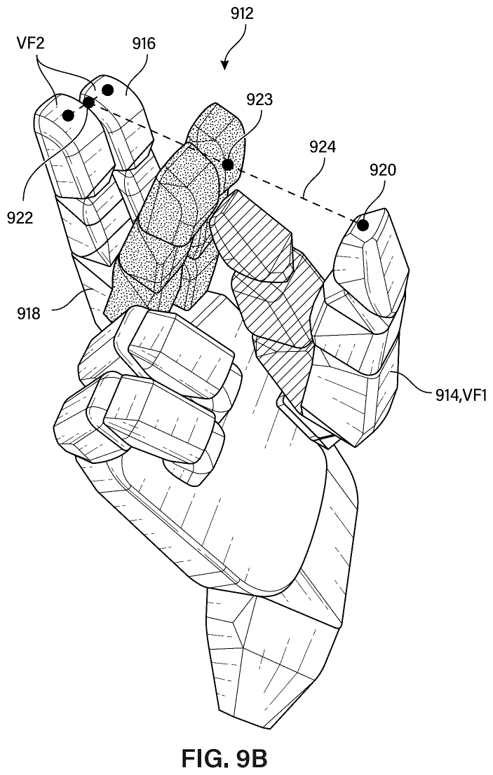

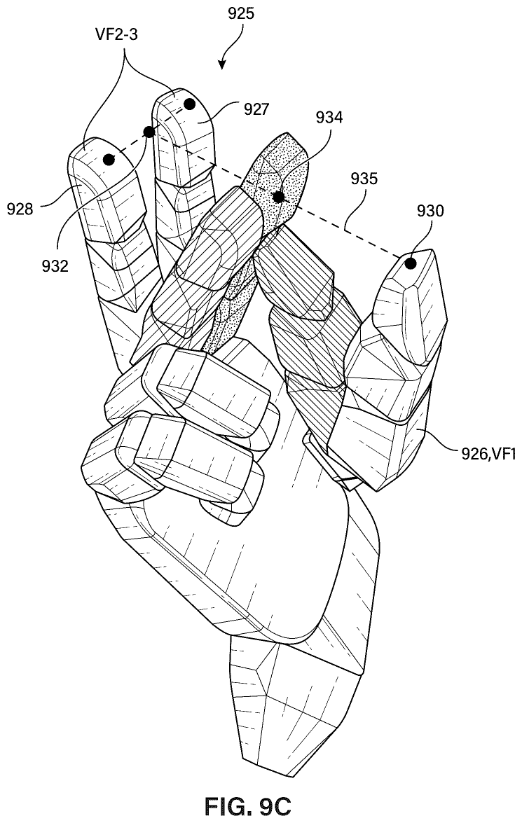

FIG. 9A is an example illustration of operation 840. A post-grasp posture 900 includes a thumb 902 and an index finger 904 that can be articulated to contact an object. In this example, the thumb 902 can be mapped to VF1, and the index finger 904 can be mapped to VF2. The virtual finger VF1 has a first closing contact point 906 that is the same as a distal contact point of the thumb 902. The virtual finger VF2 has a second closing contact point 908 that is the same as a distal contact point of the index finger 904. The closed position at which the closed hand posture is formed can be a midpoint 909 of a line 910 connecting the two closing contact points 906, 908.

FIG. 9B shows another example illustration of operation 840. A post-grasp posture 912 includes a thumb 914, an index finger 916, and a middle finger 918 that can be articulated to contact an object. In this example, the thumb 914 can be mapped to VF1, and the index finger 916 and middle finger 918 can be mapped to VF2. The virtual finger VF1 has a first closing contact point 920 that is the same as a distal contact point of the thumb 914. The virtual finger VF2 has a second closing contact point 922 that is an average of distal contact points of the index finger 916 and middle finger 918. The closed position at which the closed hand posture is formed can be a midpoint 923 of a line 924 connecting the two closing contact points 920, 922.

Returning to FIG. 8, at 850, the method has determined that the virtual finger assignment has three or more virtual fingers. Let VF1 be the virtual finger that is mapped to a thumb, and let VFX be all the other virtual fingers that are not mapped to a palm. The method includes determining a first closing contact point for VF1 and determining a second closing contact point for VFX. The first closing contact point for VF1 can be a contact point on a distal phalanx of the thumb. If VFX has only one robotic finger, the second closing contact point can be a contact point on a distal phalanx of the robotic finger. If multiple virtual fingers are included in VFX, the second closing contact point for VFX can be the average of the contact points on the distal phalanxes of the robotic fingers grouped into VFX. The method includes finding an intermediate point between the first closing contact point and the second closing contact point and selecting the intermediate point as the closed position within the grasp volume. The method continues at 860.

FIG. 9C shows an example illustration of operation 850. A post-grasp posture 925 includes a thumb 926, an index finger 927, and a middle finger 928 in a grasp posture. In this example, the thumb 926 can be mapped to VF1, the index finger 927 can be mapped to VF2, and the middle finger 928 can be mapped to VF3. Let VF2-3 be a virtual finger group including VF2 and VF3. The virtual finger VF1 has a first closing contact point 930 that is the same as a distal contact point of the thumb 926. The virtual finger group VF2-3 has a second closing contact point 932 that is an average of the closing contact points of the virtual fingers VF2 and VF3. The closing contact point of the virtual finger VF2 is the same as a distal contact point of the index finger 926, and the closing contact point of the virtual finger VF3 is the same as a distal contact point of the middle finger 928. The closed position at which the closed hand posture is formed can be a midpoint 934 of a line 935 connecting the two closing contact points 930, 932.

Returning to FIG. 8, at 860, the method includes determining a closing motion to transform the first closing contact point and the second closing contact point of the virtual fingers to the closed position. In one example, the closing motion can be determined by linear interpolation between the first closing contact point and the closed position and between the second closing contact point and the closed position.

### ADDITIONAL EXAMPLES

Additional examples based on principles described herein are enumerated below. Further examples falling within the scope of the subject matter can be configured by, for example, taking one feature of an example in isolation, taking more than one feature of an example in combination, or combining one or more features of one example with one or more features of one or more other examples.

Example 1: A method of grasp generation for a robot, the method comprising: searching within a configuration space of a robot hand model for a plurality of robot hand configurations to engage an object model with a grasp type; generating a set of candidate grasps based on the plurality of robot hand configurations; simulating grasping of the object model with the robot hand model a plurality of times for a given candidate grasp from the set of candidate grasps, wherein each simulating grasping of the object model comprises: generating a simulated grasp based on the given candidate grasp; executing the simulated grasp in a physics engine to cause the robot hand model to engage the object model with the simulated grasp; applying a wrench disturbance to the object model while the robot hand model engages the object model with the simulated grasp in the physics engine; measuring a response of the object model to the applied wrench disturbance; and assigning a grasp stability score to the simulated grasp based on the measured response; and generating a set of feasible grasps for the given candidate grasp based on the respective simulated grasps having individual grasp stability scores above a grasp stability score threshold at a target wrench disturbance.

Example 2: A method according to Example 1, wherein searching within a configuration space of the robot hand model for the plurality of robot hand configurations comprises searching for the robot hand configurations that minimize contact energy between the robot hand model and the object model, wherein the contact energy depends at least in part on a distance between a robot contact on the robot hand model and a target graspable part on the object model.

Example 3: A method according to Example 2, wherein searching within a configuration space of the robot hand model for the plurality of robot hand configurations comprises minimizing a weighted sum of the forces/torques produced at contact points between the robot hand model and the object model.

Example 4: A method according to Example 2, wherein searching within a configuration space of the robot hand model for the plurality of robot hand configurations comprises minimizing penetration of the robot hand model into the object model and minimizing self-collision of the robot hand model.

Example 5: A method according to Example 1, wherein searching within the configuration space for the plurality of robot hand configurations comprises defining a subspace of the configuration space based on a set of eigengrasps for the grasp type and searching within the subspace of the configuration space for the robot hand configurations.

Example 6: A method according to Example 5, wherein generating the set of candidate grasps based on the plurality of robot hand configurations comprises: determining a grasp quality score for each of the robot hand configurations based on a set of grasp quality metrics; and generating the set of candidate grasps based on the robot hand configurations having quality scores above a grasp quality score threshold.

Example 7: A method according to Example 6, wherein generating the set of candidate grasps based on the robot hand configurations having grasp quality scores above the grasp quality score threshold comprises: populating a given candidate grasp with a post-grasp posture from a given robot hand configuration having a grasp quality score above the grasp quality score threshold; extracting a post-grasp posture from a given robot hand configuration having a grasp quality score above the grasp quality score threshold; determining a pre-grasp posture to associate with the post-grasp posture; and populating the given candidate grasp with the pre-grasp posture and the post-grasp posture.

Example 8: A method according to Example 7, wherein determining the pre-grasp posture to associate with the post-grasp posture comprises: determining a closing motion to transform the robot hand model from the post-grasp posture to a closed hand posture that is more closed compared to the post-grasp posture; determining a trajectory to transform the robot hand model from the closed hand posture to an open hand posture that is more open compared to the pre-grasp posture based on the closing motion; and generating the pre-grasp posture based on the open hand posture.

Example 9: A method according to Example 8, wherein determining the closing motion comprises: determining a closed position within a finger volume formed by the post-grasp posture; assigning a set of virtual fingers to the robot hand model for the grasp type; and determining the closing motion to transform the set of virtual fingers from the post-grasp posture to the closed hand posture at the closed position.

Example 10: A method according to Example 7, further comprising determining a grasp trajectory to transform the robot hand model between the pre-grasp posture and the post-grasp posture for the given candidate grasp and populating the given candidate grasp with the grasp trajectory.

Example 11: A method according to Example 1, further comprising: determining a stable object pose for the object model; and determining a hand pose for the robot hand model to grasp the object model at the stable object pose; wherein searching within the configuration space of the robot hand model for the plurality of robot hand configurations to engage the object model with the grasp type comprises positioning the robot hand model at the hand pose and positioning the object model at the stable object pose.

Example 12: A method according to Example 11, wherein executing the simulated grasp in the physics engine to cause the robot hand model to engage the object model with the simulated grasp comprises positioning the robot hand model at the hand pose and positioning the object model at the stable object pose.

Example 13: A method according to Example 1, wherein generating the simulated grasp based on the given candidate grasp comprises adjusting a value of at least one parameter of the simulated grasp to be different from a value of a corresponding parameter of the given candidate grasp.

Example 14: A method according to Example 13, wherein the at least one parameter describes a post-grasp posture for the robot hand model to grasp the object model.

Example 15: A method according to Example 13, wherein adjusting the value of at least one parameter of the simulated grasp to be different from the value of the corresponding parameter of the given candidate grasp comprises adjusting at least one degree of freedom of the robot hand model to increase a degree of closeness of at least one robotic finger of the robot hand model to the object model.

Example 16: A method according to Example 1, further comprising: repeating simulating grasping of the object model with the robot hand model a plurality of times for a given candidate grasp for a plurality of candidate grasps from the set of candidate grasps, wherein each repeating simulating grasping of the object model with the robot hand model generates a plurality of simulated grasps with assigned grasp stability scores; and generating a machine learning training dataset based at least in part on the plurality of simulated grasps with assigned grasp stability scores.

Example 17: A method according to Example 1, further comprising: extracting a kinematic description of a robotic hand from a robot model; and generating the robot hand model based at least in part on the kinematic description of the robotic hand.

Example 18: One or more non-transitory computer-readable storage media storing computer-executable instructions that when executed perform operations comprising: searching within a configuration space of a robot hand model for a plurality of robot hand configurations to engage an object model with a grasp type; generating a set of candidate grasps based on the plurality of robot hand configurations; simulating grasping of the object model with the robot hand model a plurality of times for a given candidate grasp from the set of candidate grasps, wherein each simulating grasping of the object model comprises: generating a simulated grasp based on the given candidate grasp; executing the simulated grasp in a physics engine to cause the robot hand model to engage the object model with the simulated grasp; applying a wrench disturbance to the object model while the robot hand model engages the object model with the simulated grasp in the physics engine; measuring a response of the object model to the applied wrench disturbance; and assigning a grasp stability score to the simulated grasp based on the measured response; and generating a set of feasible grasps for the given candidate grasp based on the respective simulated grasps having individual grasp stability scores above a grasp stability score threshold at a target wrench disturbance.

Example 19: One or more non-transitory computer-readable storage media according to Example 18, wherein searching within the configuration space for the plurality of robot hand configurations comprises defining a subspace of the configuration space based on a set of eigengrasps for the grasp type and searching within the subspace of the configuration space for the robot hand configurations.

Example 20: A system comprising: a first processing block configured to receive a grasp template, a robot model, and an object model and output a set of candidate grasps for a robot hand model extracted from the robot model to engage the object model with a grasp type specified in the grasp template; a second processing block configured to simulate grasping of the object model with the robot hand model in a physics engine for a given candidate grasp from the set of candidate grasps and output a plurality of simulated grasps with assigned grasp stability scores for the given candidate grasp; and a third processing block configured to generate a set of feasible grasps from the plurality of simulated grasps based on the grasp stability scores.

1. A method of grasp generation for a robot, the method comprising:
searching within a configuration space of a robot hand model for a plurality of robot hand configurations to engage an object model with a grasp type;
generating a set of candidate grasps based on the plurality of robot hand configurations;
simulating grasping of the object model with the robot hand model a plurality of times for a given candidate grasp from the set of candidate grasps, wherein each simulating grasping of the object model comprises:
generating a simulated grasp based on the given candidate grasp;
executing the simulated grasp in a physics engine to cause the robot hand model to engage the object model with the simulated grasp;
applying a wrench disturbance to the object model while the robot hand model engages the object model with the simulated grasp in the physics engine;
measuring a response of the object model to the applied wrench disturbance; and
assigning a grasp stability score to the simulated grasp based on the measured response; and
generating a set of feasible grasps for the given candidate grasp based on the respective simulated grasps having individual grasp stability scores above a grasp stability score threshold at a target wrench disturbance.

2. The method of claim 1, wherein searching within a configuration space of the robot hand model for the plurality of robot hand configurations comprises searching for the robot hand configurations that minimize contact energy between the robot hand model and the object model, wherein the contact energy depends at least in part on a distance between a robot contact on the robot hand model and a target graspable part on the object model.

3. The method of claim 2, wherein searching within a configuration space of the robot hand model for the plurality of robot hand configurations comprises minimizing a weighted sum of the forces/torques produced at contact points between the robot hand model and the object model.

4. The method of claim 2, wherein searching within a configuration space of the robot hand model for the plurality of robot hand configurations comprises minimizing penetration of the robot hand model into the object model and minimizing self-collision of the robot hand model.

5. The method of claim 1, wherein searching within the configuration space for the plurality of robot hand configurations comprises defining a subspace of the configuration space based on a set of eigengrasps for the grasp type and searching within the subspace of the configuration space for the robot hand configurations.

6. The method of claim 5, wherein generating the set of candidate grasps based on the plurality of robot hand configurations comprises:
determining a grasp quality score for each of the robot hand configurations based on a set of grasp quality metrics; and
generating the set of candidate grasps based on the robot hand configurations having quality scores above a grasp quality score threshold.

7. The method of claim 6, wherein generating the set of candidate grasps based on the robot hand configurations having grasp quality scores above the grasp quality score threshold comprises:
populating a given candidate grasp with a post-grasp posture from a given robot hand configuration having a grasp quality score above the grasp quality score threshold;
extracting a post-grasp posture from a given robot hand configuration having a grasp quality score above the grasp quality score threshold;
determining a pre-grasp posture to associate with the post-grasp posture; and
populating the given candidate grasp with the pre-grasp posture and the post-grasp posture.

8. The method of claim 7, wherein determining the pre-grasp posture to associate with the post-grasp posture comprises:
determining a closing motion to transform the robot hand model from the post-grasp posture to a closed hand posture that is more closed compared to the post-grasp posture;
determining a trajectory to transform the robot hand model from the closed hand posture to an open hand posture that is more open compared to the pre-grasp posture based on the closing motion; and
generating the pre-grasp posture based on the open hand posture.

9. The method of claim 8, wherein determining the closing motion comprises:
determining a closed position within a finger volume formed by the post-grasp posture;
assigning a set of virtual fingers to the robot hand model for the grasp type; and
determining the closing motion to transform the set of virtual fingers from the post-grasp posture to the closed hand posture at the closed position.

10. The method of claim 7, further comprising determining a grasp trajectory to transform the robot hand model between the pre-grasp posture and the post-grasp posture for the given candidate grasp and populating the given candidate grasp with the grasp trajectory.

11. The method of claim 1, further comprising:
determining a stable object pose for the object model; and
determining a hand pose for the robot hand model to grasp the object model at the stable object pose;
wherein searching within the configuration space of the robot hand model for the plurality of robot hand configurations to engage the object model with the grasp type comprises positioning the robot hand model at the hand pose and positioning the object model at the stable object pose.

12. The method of claim 11, wherein executing the simulated grasp in the physics engine to cause the robot hand model to engage the object model with the simulated grasp comprises positioning the robot hand model at the hand pose and positioning the object model at the stable object pose.

13. The method of claim 1, wherein generating the simulated grasp based on the given candidate grasp comprises adjusting a value of at least one parameter of the simulated grasp to be different from a value of a corresponding parameter of the given candidate grasp.

14. The method of claim 13, wherein the at least one parameter describes a post-grasp posture for the robot hand model to grasp the object model.

15. The method of claim 13, wherein adjusting the value of at least one parameter of the simulated grasp to be different from the value of the corresponding parameter of the given candidate grasp comprises adjusting at least one degree of freedom of the robot hand model to increase a degree of closeness of at least one robotic finger of the robot hand model to the object model.

16. The method of claim 1, further comprising:
repeating simulating grasping of the object model with the robot hand model a plurality of times for a given candidate grasp for a plurality of candidate grasps from the set of candidate grasps, wherein each repeating simulating grasping of the object model with the robot hand model generates a plurality of simulated grasps with assigned grasp stability scores; and
generating a machine learning training dataset based at least in part on the plurality of simulated grasps with assigned grasp stability scores.

17. The method of claim 1, further comprising:
extracting a kinematic description of a robotic hand from a robot model; and
generating the robot hand model based at least in part on the kinematic description of the robotic hand.

18. One or more non-transitory computer-readable storage media storing computer-executable instructions that when executed perform operations comprising:
searching within a configuration space of a robot hand model for a plurality of robot hand configurations to engage an object model with a grasp type;
generating a set of candidate grasps based on the plurality of robot hand configurations;
simulating grasping of the object model with the robot hand model a plurality of times for a given candidate grasp from the set of candidate grasps, wherein each simulating grasping of the object model comprises:
generating a simulated grasp based on the given candidate grasp;
executing the simulated grasp in a physics engine to cause the robot hand model to engage the object model with the simulated grasp;
applying a wrench disturbance to the object model while the robot hand model engages the object model with the simulated grasp in the physics engine;
measuring a response of the object model to the applied wrench disturbance; and
assigning a grasp stability score to the simulated grasp based on the measured response; and
generating a set of feasible grasps for the given candidate grasp based on the respective simulated grasps having individual grasp stability scores above a grasp stability score threshold at a target wrench disturbance.

19. The one or more non-transitory computer-readable storage media of claim 18, wherein searching within the configuration space for the plurality of robot hand configurations comprises defining a subspace of the configuration space based on a set of eigengrasps for the grasp type and searching within the subspace of the configuration space for the robot hand configurations.

20. A system comprising:
a first processing block configured to receive a grasp template, a robot model, and an object model and output a set of candidate grasps for a robot hand model extracted from the robot model to engage the object model with a grasp type specified in the grasp template;
a second processing block configured to simulate grasping of the object model with the robot hand model in a physics engine for a given candidate grasp from the set of candidate grasps and output a plurality of simulated grasps with assigned grasp stability scores for the given candidate grasp; and
a third processing block configured to generate a set of feasible grasps from the plurality of simulated grasps based on the grasp stability scores.
